(19) United States
(12) Patent Application Publication
(10) Pub. No.: US 2025/0225584 A1
(43) Pub. Date: Jul. 10, 2025

(54) SYSTEMS AND METHODS FOR ARTIFICIAL INTELLIGENCE OPTIMIZATION OF PRODUCT COMBINATION

(71) Applicant: FIDELITY INFORMATION SERVICES, LLC, Jacksonville, FL (US)

(72) Inventors: Benjamin WELLMANN, Delray Beach, FL (US); Amit AGGARWAL, Ontario (CA); Lance Charles TAPPA, Sussex, WI (US); Vivek Ravi KUMAR, Bangalore (IN)

(73) Assignee: FIDELITY INFORMATION SERVICES, LLC, Jacksonville, FL (US)

(21) Appl. No.: 18/588,432

(22) Filed: Feb. 27, 2024

(30) Foreign Application Priority Data
Jan. 10, 2024 (IN) 202411001789

(51) Int. Cl. G06Q 40/06; G06Q 10/0637; G06Q 30/0204

(52) U.S. Cl. CPC G06Q 40/06; G06Q 10/06375; G06Q 30/0205

(57) ABSTRACT

Systems and methods for optimizing the combination of products and services a business offers to customers, identifying a combination of top markets a business offers to customers for growth opportunities, and optimizing advertisements. In one implementation, the disclosed system includes at least one processing device and at least one non-transitory memory containing software code configured to cause the processing device to: gather customer data and financial institution data from a plurality of data sources; extract a plurality of customer behavior features and a plurality of financial institution behavior features; process the customer behavior features and financial institution behavior features using one or more trained foundation models; input the foundation model outputs and a plurality of goal inputs into a trained product model; and output a natural-language product response.

### CROSS-REFERENCE TO RELATED APPLICATIONS

This application claims the benefit of foreign priority of IN 202411001789, filed Jan. 10, 2024, the entire contents of which are incorporated herein by reference.

### FIELD OF THE DISCLOSURE

The disclosed embodiments generally relate to systems and methods for optimizing the combination of products and services a business offers to customers powered by artificial intelligence. Disclosed embodiments also generally relate to systems and methods for identifying a combination of top markets a business offers to customers for growth opportunities, powered by artificial intelligence. Further, disclosed embodiments generally relate to systems and methods for developing optimized advertisements, powered by artificial intelligence.

### BACKGROUND

Financial institutions are organizations that provide a range of financial services to individuals, businesses, and governments. Financial institutions offer products and services to meet the needs of their clients. For example, commercial banks offer checking accounts, credit cards, and loans. Investment banks offer mergers and acquisitions (M&A) advising, trading and brokerage services, and asset management services. Financial institutions traditionally decide which products to offer clients based on a combination of market demand, customer needs, profitability considerations, and strategic goals.

Financial institutions tend to offer the same products and services to groups of customers, which may have different needs. At present, computer systems for recommending products and services exist, but they fail to accurately capture all data, and fail to utilize machine learning techniques to forecast customer decisions. Further, computer systems for identifying growth opportunities and developing advertisements exist, but they fail to accurately capture all data and fail to utilize machine learning techniques to forecast customer decisions. In fact, current systems only use high-level customer relationship management (CRM) data and some external simple market data to recommend products, identify growth opportunities, and develop advertisements.

These current systems only use descriptive analytics instead of predictive or prescriptive recommendations. This traditional approach is flawed, as it lacks granularity, nuance, and customization.

Segmentation allows financial institutions to tailor their strategies, products, and services to different groups of people with similar characteristics, needs, and preferences. For example, banking segmentation refers to the practice of dividing a bank's customer base into distinct groups or segments based on various characteristics such a demographics, behaviors, needs, and preferences. Currently, financial institutions rely on basic assumptions of groups of customers and have a coarse approach to segmentation and product targeting. For example, financial institutions may base their segmentation around one customer segment category (e.g., gender, income, geographic location, education). This traditional approach to segmentation is limited because it lacks granularity and nuance. Further, it treats each segment as a homogenized group, which is not the case.

### SUMMARY

Embodiments of the present disclosure address the aforementioned limitations by developing individualized systems and methods for artificial-intelligence based product optimization of products and services for offer, identifying a combination of geographic areas for growth, and developing optimized advertisements. It is to be appreciated that embodiments of the present disclosure are not limited to financial industries, and may span to banking, asset wealth management, retirement, financial service, or any industry where a better understanding of net worth, spending or saving behaviors are relevant. For example, technology advertising companies may utilize embodiments of the present disclosure as precursors or additional inputs into larger advertising models. Specifically, machine learning may be used to identify an ideal combination of products to offer clients, based on multiple segments at once as well as financial institution goals. This may include actions to close gaps in coverage or to improve a financial institution's market position. Further, machine learning may be used to identify a combination of geographic areas for growth. Disclosed embodiments also include developing optimized advertisements using machine learning.

The system includes at least one processing device and at least one non-transitory memory storing instructions to perform operations when executed by the at least one processing device. The operations include gathering data from a plurality of data sources; extracting, using a machine learning algorithm, a plurality of customer behavior features based on the customer data and a plurality of financial institution behavior features based on the financial institution data; processing the customer behavior features and financial institution behavior features using one or more trained foundation models, wherein the trained foundation models are selected based on a plurality of foundation model selection variables, and wherein the trained foundation models output one or more foundation model outputs; inputting the foundation model outputs and a plurality of goal inputs into a trained product model, wherein the goal inputs comprise a plurality of financial institution products and one or more of a plurality of financial institution parameters, an plurality of financial institution regions, or a plurality of financial institution growth strategies; the trained product model is trained based on the foundation model outputs and the goal inputs; outputting, from the trained product model, a plurality of natural-language target product outputs, wherein the target product outputs are based on the goal inputs.

In some embodiments, the data sources comprise one or more of bank core system, customer relationship management system, credit bureau system, country-level asset data system, survey, broker systems or external sources; the gathered data comprises one or more of a customer profile data, transaction history data, demographic information data, economic indicator data, household asset data, internal financial institution data, credit report data, or broker data; the customer behavior features comprise one or more of customer lifetime value, spending patterns, or income levels; and the financial institution behavior features comprise one or more of financial preferences or regional characteristics.

In some embodiments, the foundation model selection variables comprise one or more of the goal inputs; and the processing device is further configured to: update the customer data at predetermined times; provide the updated data to the machine learning algorithm through a first feedback loop; and modify the customer behavior features and foundation model outputs based upon information received from the first feedback loop to refine the machine learning algorithm.

In some embodiments, the trained product model comprises one or more of a logistic regression, a random forest, a gradient boosting, a clustering algorithm, or a deep learning model; and the processing device is further configured to: update the goal inputs at predetermined times; provide the updated goal input data to the trained product model in a second feedback loop; and train the trained product model based upon information received from the second feedback loop to refine the trained product model.

In some embodiments, the processing device is further configured to: receive customer feedback through one or more customer feedback channels, wherein the customer data further comprises the customer feedback; and adjust the goal inputs based on the customer feedback.

In some embodiments, the trained product model is further configured for collaborative filtering, content-based filtering, and hybrid recommendation filtering.

In some embodiments, the processing device is further configured to: monitor the trained product model performance according to one or more trained product model metrics at predetermined times; and refine the trained product model according to the trained product model performance.

In some embodiments, the target product output is based on a household segment or a client segment; and comprises a ranking and a likelihood scoring.

In some embodiments, the system further comprises a user interface configured to provide the user interface to a user device, receive an input from the user device on one or more elements of the user interface, and update the one or more of the data sources, the data, the machine learning algorithm, the customer behavior features, the financial institution behavior features, the trained models, the foundation model selection variables, the trained models, the foundation model selection variables, the goal inputs, or the trained product model in response to the input, and display an updated product response based on the input.

Embodiments of the present disclosure may include a method for artificial-intelligence based product optimization of products and services for offer. Method may comprise: gathering data from a plurality of data sources; extracting, using a machine learning algorithm, a plurality of customer behavior features and a plurality of financial institution behavior features based on the data; processing the customer behavior features and financial institution behavior features using one or more trained foundation models, wherein the trained foundation models are selected based on a plurality of foundation model selection variables, and wherein the trained foundation models output one or more foundation model outputs; inputting the foundation model outputs and a plurality of goal inputs into a trained product model, wherein the goal inputs comprise a plurality of financial institution products and one or more of a plurality of financial institution parameters, a plurality of financial institution regions, or a plurality of financial institution growth strategies; the trained product model is trained based on the foundation model outputs and the goal inputs; outputting, from the trained product model, a plurality of natural-language target product outputs, wherein the target product outputs are based on the goal inputs.

Embodiments of the present disclosure may include a system for identifying, using artificial intelligence, a combination of top markets a business offers to customers for growth opportunities, with at least one processing device and at least one non-transitory memory storing instructions to perform operations when executed by the at least one processing device. The operations include gathering data from a plurality of data sources; extracting, using a machine learning algorithm, a plurality of customer behavior features and a plurality of financial institution behavior features based on the data; processing the customer behavior features and financial institution behavior features using one or more trained foundation models, wherein the trained foundation models are selected based on a plurality of foundation model selection variables, and wherein the trained foundation models output one or more foundation model outputs related to one or more of a competitiveness of a market or a future outlook of a region for a product; inputting the foundation model outputs and a plurality of goal inputs into a trained product model, wherein the goal inputs comprise a plurality of financial institution products and one or more of a plurality of financial institution parameters, a plurality of financial institution regions, a plurality of financial institution growth strategies, a target product output, a financial institution marketing budget, or a customer focus; the trained growth opportunity model is trained based on the foundation model outputs and the goal inputs; outputting, from the trained growth opportunity model, a plurality of natural-language target market outputs, wherein the target market outputs are based on the goal inputs.

In some embodiments, the foundation model selection variables comprise one or more of the goal inputs; and the processing device is further configured to: update the data at predetermined times; provide the updated data to the machine learning algorithm through a first feedback loop; and modify the customer behavior features, financial institution features, foundation model outputs based upon information received from the first feedback loop to refine the machine learning algorithm.

In some embodiments, the trained growth opportunity model comprises one or more of a logistic regression, a random forest, a gradient boosting, a clustering algorithm, or a deep learning model; and the processing device is further configured to: update the goal inputs at predetermined times; provide the updated goal input data to the trained growth opportunity model in a second feedback loop; and train the trained growth opportunity model based upon information received from the second feedback loop to refine the trained growth opportunity model.

In some embodiments, the processing device is further configured to: receive customer feedback through one or more customer feedback channels, wherein the customer data further comprises the customer feedback; and adjust the goal inputs based on the customer feedback.

In some embodiments, the trained model is further configured for collaborative filtering, content-based filtering, and hybrid recommendation filtering.

In some embodiments, the processing device is further configured to: monitor the trained growth opportunity model performance according to one or more trained growth opportunity model metrics at predetermined times; and refine the trained growth opportunity model according to the trained growth opportunity model performance.

In some embodiments, the market response is based on a market segment including one or more of a demographic segment, a geographic segment, a psychographic segment, a behavioral segment, or a regional segment including one or more of a geographic scope, state, province, district, or parish and comprises a ranking and a likelihood scoring.

In some embodiments, the system further comprises a user interface configured to provide the user interface to a user device, receive an input from the user device from the user device on one or more elements of the user interface, and update the one or more of the data sources, the data, the machine learning algorithm, the customer behavior features, the trained models, the foundation model selection variables, the goal inputs, or the trained growth opportunity model in response to the input, and display an updated market response based on the input.

Embodiments of the present disclosure may include a system for identifying, using artificial intelligence, a combination of geographic areas for growth. An exemplary method may comprise: gathering data from a plurality of data sources; extracting, using a machine learning algorithm, a plurality of customer behavior features and a plurality of financial institution behavior features based on the data; processing the customer behavior features and financial institution behavior features using one or more trained foundation models, wherein the trained foundation models are selected based on a plurality of foundation model selection variables, and wherein the trained foundation models output one or more foundation model outputs related to one or more of a competitiveness of a market or a future outlook of a region for a product; input the foundation model outputs and a plurality of goal inputs into a trained growth opportunities model, wherein the goal inputs comprise a plurality of financial institution products and one or more of a plurality of financial institution parameters, an plurality of financial institution regions, or a plurality of financial institution growth strategies; the trained product model is trained based on the foundation model outputs and the goal inputs; outputting, from the trained product model, a plurality of natural-language target market outputs, wherein the target market outputs are based on the goal inputs.

Embodiments of the present disclosure may include a system for developing optimized advertisements, with at least one processing device and at least one non-transitory memory storing instructions to perform operations when executed by the at least one processing device. The operations include gathering data from a plurality of data sources; extracting, using a machine learning algorithm, a plurality of customer behavior and a plurality of financial institution behavior features based on the data; processing the customer behavior features and financial institution behavior features using one or more trained foundation models, wherein the trained foundation models are selected based on a plurality of foundation model selection variables, and wherein the trained foundation models output one or more foundation model outputs related to an advertisement instruction; inputting the foundation model outputs and a plurality of goal inputs into a trained campaign execution model, wherein the goal inputs comprise one or more of a plurality of financial institution products, a plurality of financial institution product variants, a plurality of financial institution parameters, an plurality of financial institution regions, a plurality of financial institution growth strategies, a response, a campaign duration, a campaign budget, or an available campaign channel; the trained campaign execution model is trained based on the foundation model outputs and the goal inputs; outputting, from the trained campaign execution model, a plurality of natural-language campaign execution outputs, wherein the campaign execution outputs are based on the goal inputs.

In some embodiments, the foundation model selection variables comprise one or more of the goal inputs; and the processing device is further configured to: update the data at predetermined times; provide the updated data to the machine learning algorithm through a first feedback loop; and modify the customer behavior features, financial institution features, and the foundation model outputs based upon information received from the first feedback loop to refine the machine learning algorithm.

In some embodiments, the trained campaign execution model comprises one or more of a logistic regression, a random forest, a gradient boosting, a clustering algorithm, or a deep learning model; and the processing device is further configured to: update the goal inputs at predetermined times; provide the updated goal input data to the trained campaign execution model in a second feedback loop; and train the campaign execution model based upon information received from the second feedback loop to refine the trained campaign execution model.

In some embodiments, the processing device is further configured to: receive customer feedback through one or more customer feedback channels, wherein the customer data further comprises the customer feedback; and adjust the goal inputs based on the customer feedback.

In some embodiments, the processing device is further configured to: monitor the trained campaign execution model performance according to one or more trained campaign execution model metrics at predetermined times; and refine the trained campaign execution model according to the trained campaign execution model performance.

In some embodiments, the target campaign output comprises an ad instruction and the processor is further configured to monitor a plurality of key performance indicators, update the trained campaign execution model based on the key performance indicators in a fourth feedback loop, and train the trained campaign execution model based upon information received from the fourth feedback loop to refine the trained campaign execution model.

In some embodiments, the system further comprises a user interface configured to provide a user interface to a user device, receive an input from the user device on one or more elements of the user interface, update the one or more data sources, the data the machine learning algorithm, the customer behavior features, the financial model selection variables, the goal inputs, or the trained campaign execution model in response to the input and display an updated advertisement response based on the input advertisement response.

Embodiments of the present disclosure may include a method for developing, using artificial intelligence, optimized advertisements. Method may comprise: gathering data from a plurality of data sources; extracting, using a machine learning algorithm, a plurality of customer behavior features and a plurality of financial institution behavior features based on the data; processing the customer behavior features and financial institution behavior features using one or more trained foundation models, wherein the trained foundation models are selected based on a plurality of foundation model selection variables, and wherein the trained foundation models output one or more foundation model outputs related to an advertisement instruction; input the foundation model outputs and a plurality of goal inputs into a trained campaign execution model, wherein the goal inputs comprise one or more of a plurality of financial institution products, a plurality of financial institution parameters, a plurality of financial institution regions, a plurality of financial institution growth strategies, a response, a campaign duration, a campaign budget, or a campaign channel; the trained campaign execution model is trained based on the foundation model outputs and the goal inputs; outputting, from the trained campaign execution model, a natural-language target campaign execution output, wherein the target campaign output is based on the goal inputs.

### BRIEF DESCRIPTION OF THE DRAWINGS

FIG. 1 depicts an exemplary system diagram for optimizing the combination of products and services a business offers to customers, which outputs a target product output, consistent with disclosed embodiments.

FIG. 2 depicts an exemplary system architecture diagram for optimizing the combination of products and services a business offers to customers, which outputs a response including a product offering, product variants, and parameters, consistent with disclosed embodiments.

FIG. 3 depicts an exemplary method for optimizing the combination of products and services a business offers to customers, which results in a target product output, consistent with disclosed embodiments.

FIG. 4 depicts a first exemplary user interface for optimizing the combination of products and services a business offers to customers, which displays a target product output and includes filters and an insight panel, consistent with disclosed embodiments.

FIG. 5 depicts a second exemplary user interface for optimizing the combination of products and services a business offers to customers displaying detailed product opportunity information, consistent with disclosed embodiments.

FIG. 6 depicts a third exemplary user interface for optimizing the combination of products and services a business offers to customers, including a maximum investment potential panel, consistent with disclosed embodiments.

FIG. 7 depicts an exemplary system architecture diagram for identifying a combination of top markets a business offers to customers for growth opportunities, consistent with disclosed embodiments.

FIG. 8 depicts an exemplary system architecture diagram for optimizing advertisements, consistent with disclosed embodiments.

### DETAILED DESCRIPTION

The following detailed description refers to the accompanying drawings. Wherever possible, the same reference numbers are used in the drawings and the following description to refer to the same or similar parts. While several illustrative embodiments are described herein, modifications, adaptations and other implementations are possible. For example, substitutions, additions, or modifications may be made to the components and steps illustrated in the drawings, and the illustrative methods described herein may be modified by substituting, reordering, removing, or adding steps to the disclosed methods. Accordingly, the following detailed description is not limited to the disclosed embodiments and examples. Instead, the proper scope of the invention is defined by the appended claims.

Some embodiments of the present disclosure are directed to systems and methods configured for optimizing the combination of products and services a business offers to customers. The system includes at least one processing device and at least one non-transitory memory storing instructions to perform operations when executed by the at least one processing device. The operations include gathering customer data and financial institution data from a plurality of data sources; extracting, using a machine learning algorithm, a plurality of customer behavior features based on the customer data and a plurality of financial institution behavior features based on the financial institution data; processing the customer behavior features and financial institution behavior features using one or more trained foundation models, wherein the trained foundation models are selected based on a plurality of foundation model selection variables, and wherein the trained foundation models output one or more foundation model outputs; input the foundation model outputs and a plurality of goal inputs into a trained product model, wherein the goal inputs comprise a plurality of financial institution products and one or more of a plurality of financial institution parameters, an plurality of financial institution regions, or a plurality of financial institution growth strategies; the trained product model is trained based on the foundation model outputs and the goal inputs; outputting, from the trained product model, a plurality of natural-language target product outputs, wherein the target product outputs are based on the goal inputs.

Other embodiments of the present disclosure are directed to systems and methods configured for identifying a combination of top markets a business offers to customers for growth opportunities. The system includes at least one processing device and at least one non-transitory memory storing instructions to perform operations when executed by the at least one processing device. The operations include gathering customer data and financial institution data from a plurality of data sources; extracting, using a machine learning algorithm, a plurality of customer behavior features based on the customer data and a plurality of financial institution behavior features based on the financial institution data; processing the customer behavior features and financial institution behavior features using one or more trained foundation models, wherein the trained foundation models are selected based on a plurality of foundation model selection variables, and wherein the trained foundation models output one or more foundation model outputs; input the foundation model outputs and a plurality of goal inputs into a trained growth opportunity model, wherein the goal inputs comprise a plurality of financial institution products and one or more of a plurality of financial institution parameters, an plurality of financial institution regions, a plurality of financial institution growth strategies, a target product output, a financial institution marketing budget, or a customer focus; the trained growth opportunity model is trained based on the foundation model outputs and the goal inputs; outputting, from the trained growth opportunity model, a plurality of natural-language target market outputs, wherein the target market outputs are based on the goal inputs.

Other embodiments of the present disclosure are directed to systems and methods configured for developing optimized advertisements using machine learning. The system includes at least one processing device and at least one non-transitory memory storing instructions to perform operations when executed by the at least one processing device. The operations include gathering customer data and financial institution data from a plurality of data sources; extracting, using a machine learning algorithm, a plurality of customer behavior features based on the customer data and a plurality of financial institution behavior features based on the financial institution data; processing the customer behavior features and financial institution behavior features using one or more trained foundation models, wherein the trained foundation models are selected based on a plurality of foundation model selection variables, and wherein the trained foundation models output one or more foundation model outputs; input the foundation model outputs and a plurality of goal inputs into a trained campaign execution model, wherein the goal inputs comprise one or more of a plurality of financial institution products, a plurality of financial institution parameters, an plurality of financial institution regions, a plurality of financial institution growth strategies, a response, a campaign duration, a campaign budget, or an available channel; the trained campaign execution model is trained based on the foundation model outputs and the goal inputs; outputting, from the trained campaign execution model, a plurality of natural-language target campaign execution outputs, wherein the target campaign execution outputs are based on the goal inputs.

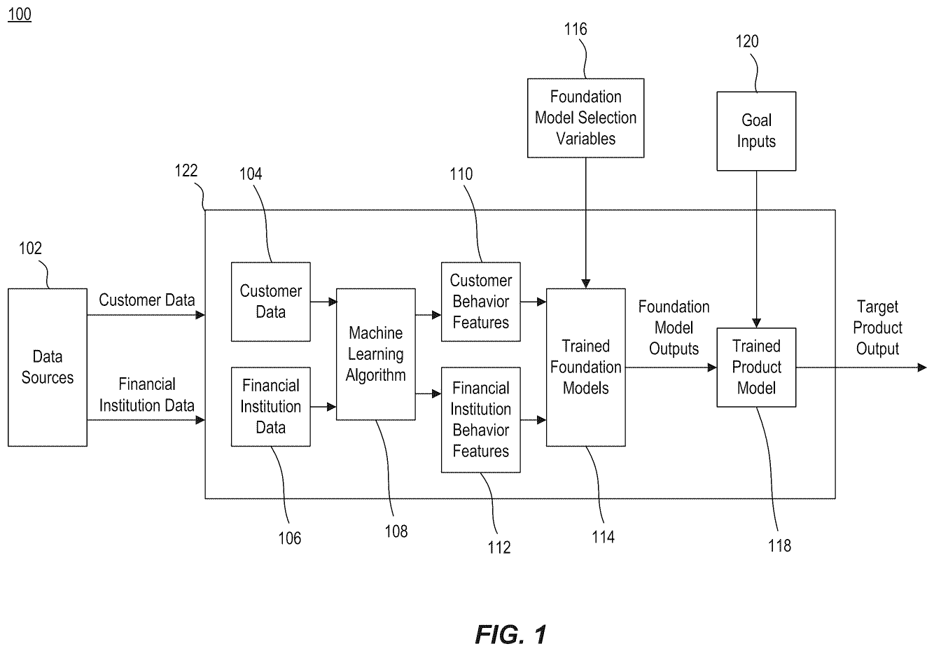

Referring to FIG. 1, an exemplary system 100 for optimizing the combination of products and services a business offers to customers, consistent with disclosed embodiments is shown. System 100 comprises: data sources 102, customer data 104, financial institution data 106, machine learning algorithm 108, customer behavior features 110, financial institution behavior features 112, trained foundation models 114, foundation model selection variables 116, trained product model 118, goal inputs 120, and processing device 122. As described below with respect to at least FIG. 1, system 100 may be software-based, hardware-based, or both software and hardware-based. For example, some disclosed embodiments may be software-based and may not require any specified hardware support.

Processing device 122, in some embodiments, may include any physical device or group of devices having electric circuitry that performs a logic operation on an input or inputs. Processing device 122 may comprise one or more electronic processors used to process instructions inside of a computer or other electronic system. For example, a processing device 122 or at least one processing device 122 may include one or more integrated circuits (IC), including an application-specific integrated circuit (ASIC), a microchip, a microcontroller, a microprocessor, all or part of a central processing unit (CPU), a graphics processing unit (GPU), a digital signal processor (DSP), a field-programmable gate array (FPGA), a neural processing unit (NPUs), an AI accelerator, a server, a virtual server, a virtual computing instance (e.g., a virtual machine or a container), a microprocessor, or other circuits suitable for executing instructions of performing logic operations. The instructions executed by at least one processing device 122 may, for example, be pre-loaded into a memory integrated with or embedded into the controller or may be stored in a separate memory. The memory may include a Random Access Memory (RAM), a Read-Only Memory (ROM), a hard disk, an optical disk, a magnetic medium, a flash memory, other permanent, fixed, or volatile memory, or any other mechanism capable of storing instructions. In some embodiments, the at least one processing device 122 may include more than one processing device. Each processing device 122 may have a similar construction, or the processing devices 122 may be of differing constructions that are electrically connected or disconnected from each other. For example, the processing devices 122 may be separate circuits or integrated in a single circuit. When more than one processing device 122 is used, the processing devices 122 may be configured to operate independently or collaboratively and may be co-located or located remotely from each other. The processing device 122 may be coupled electrically, magnetically, optically, acoustically, mechanically or by other means that permit them to interact. For example, processing device 122 may be a processing device created by one or more of Intel, AMD, Nvidia, Qualcomm, Apple, or IBM. Some disclosed embodiments may be software-based and may not require any specified hardware support.

Data sources 102, in some embodiments, refer to a system, method, or device that produces or provides data to the system 100. Non-limiting examples of data sources 102 include databases, data warehouses, sensors, web services, files, tables, images, Application Programming Interfaces (APIs), or any other repository that produces or provides data. Further, data in the data sources 102 may be stored in relational databases (e.g., MySQL, Oracle Database, Microsoft SQL Server), noSQL databases (e.g., MongoDB, Redis), cloud-based databases (e.g., Google Cloud Firestore, Microsoft Azure), in-memory databases (e.g., Redis, SAP HANA), file systems (e.g., NTFS, HFS+, ext4), columnar databases (e.g., Amazon Redshift, Apache Cassandra), graph databases (e.g., Neo4j, Amazon Neptune), or distributed databases (e.g., Apache Cassandra, MongoDB). Data sources 102 may comprise structured and unstructured data, real-time or historical data. Data sources 102 may be added, removed, or updated at any stage of the system or method described herein. In some embodiments, data sources 102 may be software-based and may not require any specified hardware support.

In some embodiments, data sources 102 may include bank core system, customer management system (CRM), credit bureau system, country-level asset data system, surveys, broker system, or any other external sources that provide customer data or financial institution data. Bank core system refers to banking software systems that enable a bank to conduct operations such as processing transactions, managing accounts, and maintaining customer records. Bank core system, in some embodiments, involve customer information management, account management, transaction processing, loan management, credit scoring, risk management, payments processing, compliance, regulatory reporting, security, authentication, channel integration, real-time updates, customer relationship management, reporting, and analytics. Non-limiting examples of bank core systems include FIS Core Banking, Oracle Financial Services Analytical Applications, IBM Banking Data Warehouse, or any other core banking system that manages key banking functions and operations of a financial institution. It is to be appreciated bank core system may be one or more bank core systems.

Customer data 104 refers to a system, method, or device that relates to information regarding current customers, previous customers, potential customers, or anyone or entity that may be considered of interest for data collection. For example, in some embodiments, customer data may include customer profiles, transaction history, demographics, economic indicators, household assets, or credit reports. Customer data may be stored in databases, data warehouses, web services, files, tables, images, or any other repository that stores data. In some embodiments, customer data 104 may be hardware or software.

Financial institution data 106 refers to a system, method, or device that relates to information regarding the financial industry, such as banking and investing data. For example, financial institution data may include customer data (e.g., financial information, account details, transaction history), risk management data (e.g., credit risk data, fraud detection data), operational data (e.g., transaction processing data, customer service records), regulatory and compliance data, market and economic data (e.g., interest rates, market indices, economic indicators), investment data (e.g., portfolio information, market research), or insurance data (e.g., policyholder information, claims data). In some embodiments, financial institution data may include one or more of internal financial institution data, credit report data, or broker data. Financial institution data may be stored in databases, data warehouses, web services, files, tables, images, or any other repository that stores data. In some embodiments, financial institution data 106 may be hardware or software.

While customer data 104 and financial institution data 106 are depicted in FIG. 1 as separate systems, methods, or devices that relate to or provide different kinds of data, in some embodiments, a single system, method or device may relate to or provide a single type of data or multiple types of data.

Customer management system refer to a system, method, or device that enables banks and financial institutions to manage their relationships with customers efficiently. Customer management system may help banks provide personalized services and experiences to their customers. For example, customer management system may involve customer data management, customer segmentation, interaction tracking, and customer service. Non-limiting examples of customer management system include Salesforce, Microsoft Dynamics 365, Oracle CX Cloud, or any other customer management system that manages customer relationships. Customer management system data may be stored in databases, data warehouses, web services, files, tables, images, or any other repository that stores data. In some embodiments, customer management systems may be hardware or software. It is to be appreciated customer management system may be one or more customer management systems.

Credit bureau system 208 refers to a system, method, or device related to credit reporting agencies that collect and maintain consumer credit information. Credit bureau system 208 may involve credit reporting, credit scoring, and risk assessment of customers. Non-limiting examples of credit bureau systems include Equifax, TransUnion, or any other credit reporting agency that collects and maintains information about credit history and financial behaviors. Credit bureau system data may be stored in databases, data warehouses, web services, files, tables, images, or any other repository that stores data. It is to be appreciated credit bureau system may be one or more credit bureau systems.

County-level asset data system 212 refer to a system, method, or device that relates to assets within a specific county or geographic area. County-level asset data system 212 may include information related to real estate assets, infrastructure assets, economic assets, financial assets, natural resources, demographic assets, cultural and recreational assets, government assets, agricultural assets, or healthcare assets. County-level asset data system 212 may be obtained, in some embodiments, through governmental agencies (e.g., county clerk's office, local assessor's office), property records, tax assessments, county GIS departments, economic development offices, U.S. Census Bureau, Environmental Protection agencies, local research institutions (e.g., universities, non-profits), commercial data providers, public databases, or any other means of retrieving county-level asset data. County-level asset data system 212 may be stored in databases, data warehouses, web services, files, tables, images, or any other repository that stores data. It is to be appreciated county-level asset data system may be one or more county-level asset data systems. Moreover, while system 212 is described here as a “county-level asset data system,” one of ordinary skill will understand that in other embodiments other geographic or political subdivisions may be used to define or divide the data included in system 212 (e.g., state, province, district, parish, etc.)

Surveys 214 refer to a system, method, or device related to information collected from a sample of individuals or entities. Surveys may involve structured questions, sampling, quantitative data, objective, standardization, and analysis. Non-limiting examples of surveys include questionnaire surveys, interview surveys, online surveys, telephone surveys, mail surveys, face-to-face surveys, cross-sectional surveys, or longitudinal surveys. Survey data may be stored in databases, data warehouses, web services, files, tables, images, or any other repository that stores data. In one embodiment, survey 214 may include a federal reserve consumer survey. It is to be appreciated surveys may be one or more survey.

Broker system refers to a system, method, or device related to managing transactions, connecting buyers and sellers, and providing information for decision-making. Broker system may be involved with stocks, bonds, commodities, currencies, or other securities. Further, broker system may have information regarding market data, research reports, company financials, investment products, regulatory information, client profiles, market trends, interest rates, economic indicators, or tax considerations. In some embodiments, broker system includes features for market analysis, order execution, or client management. Broker system data may be stored in databases, data warehouses, web services, files, tables, images, or any other repository that stores data. It is to be appreciated broker system may be one or more broker systems.

External sources refer to a system, method, or device an organization accesses or collects from outside its internal systems or databases. External data may supplement an organization's internal data and help with making informed decisions, conducting analyses, and gaining insights. Non-limiting examples of external data refers to information from a public database, third-party providers, social media, web data, government reports, publications, surveys, market research, financial markets data, customer data, industry reports, industry studies, or media sources. External source data may be stored in databases, data warehouses, web services, files, tables, images, or any other repository that stores data. It is to be appreciated external sources may be one or more external sources.

In some embodiments, data sources 102 collect, generate, acquire, store, and manage data. Further, In some embodiments, processing device 122 gathers data (e.g., customer data, financial institution data) from data sources 102. Customer data refers to a system, method, or device related to information regarding current customers, previous customers, potential customers, or anyone who may be considered of interest for data collection. Customer data may be stored in databases, data warehouses, web services, files, tables, images, or any other repository that stores data (e.g., customer data 104). For example, in some embodiments, customer data may include customer profiles, transaction history, demographics, economic indicators, household assets, or credit reports. Financial institution data refers to a system, method, or device related to information regarding the financial industry, such as operations, transactions, and overall functioning of banks, credit unions, insurance companies, or investment firms. In some embodiments, financial institution data may include one or more of internal financial institution data, credit report data, or broker data. Financial institution data may be stored in databases, data warehouses, web services, files, tables, images, or any other repository that stores data (e.g., financial institution data 106). Some disclosed embodiments may be software-based and may not require any specified hardware support.

Credit report data refers to a system, method, or device that related to a detailed record of an individual's credit history and financial behavior. Credit report data, in some embodiments, include personal information (e.g., address, current employer, previous employer), credit accounts (e.g., list of credit accounts, account numbers, credit limit, loan amount, current balance), credit inquiries (e.g., record of inquiries made by lenders when individual applied for credit), public records (e.g., bankruptcies, tax liens), payment history (e.g., late payments, missed payments, timeliness of payments), credit utilization (e.g., percentage of available credit being used), collection accounts, derogatory marks, or credit score. Credit report data may be stored in databases, data warehouses, web services, files, tables, images, or any other repository that stores data. Some disclosed embodiments may be software-based and may not require any specified hardware support.

Broker data refers to a system, method, or device related to information associated with broker systems or brokerage firms. Broker data, in some embodiments, may involve regulatory compliance information, trading platforms, fee structure, account types, market analysis, trade information, account statements, regulatory disclosures, and margin requirements. Broker data may be stored in databases, data warehouses, web services, files, tables, images, or any other repository that stores data. Some disclosed embodiments may be software-based and may not require any specified hardware support.

Processing device 122 gathering data (e.g., customer data, financial institution data) from data sources 102, in some embodiments, involves collecting, compiling, extracting, storing, or organizing data from data sources 102. For example, processing device 122 may gather data (e.g., customer data, financial institution data) by reading information stored in data sources 102 such as files, databases, or documents. In some embodiments, processing device 122 may gather data over a network (e.g., Ethernet, Wi-Fi, Bluetooth), graphical user interface, command-line interface, or Application Programming Interface (APIs). In some embodiments, processing device 122 may gather customer data or financial institution data from data sources 102 and store the gathered data. For example, processing device 122 may store the customer data in a database (e.g., customer data 104) and store the financial institution data in a database (e.g., financial institution data 106). Additionally, or alternatively, processing device 122 may store the gathered customer data and financial institution data in a common database where both customer data and financial institution data is stored (i.e., not separate databases). A database refers to a structured collection of data that is organized in a way to facilitate efficient storage, retrieval, and management of data. Non-limiting examples of databases include relational databases (e.g., MySQL, Oracle Database), NoSQL database (e.g., MongoDB, Cassandra, Redis), cloud-based database (e.g., Amazon DynamoDB, Google Cloud Firestore, Microsoft Azure Cosmos DB), or distributed databases (e.g., Apache Cassandra). Processing device 122 may communicate with a database, retrieve information from database, send information to database, store information in database, manipulate information in database, or otherwise control the operations of the database.

In some embodiments, processing device 122 may collect and preprocess data (e.g., customer data 104 and financial institution data 106) so it is in a suitable or compatible format for the machine learning algorithm 108. This may involve cleaning the data, handling missing values, scaling features, or normalizing features. In some embodiments, processing device 122 cleanses the data, identifying and correcting errors, inconsistencies, and inaccuracies in the dataset. For example, processing device 122 may delete rows with missing columns, input missing values with averages, detect and remove duplicate records from the dataset, standardize data formats, correct typos, remove outliers, normalize data to bring it to a common scale, detect data integrity issues, validating data against external sources, or enforce constraints. In some embodiments, processing device 122 may select which machine learning algorithm 108 and in what order machine learning algorithm 108 are implemented, based on the nature of the task and the characteristics of the data.

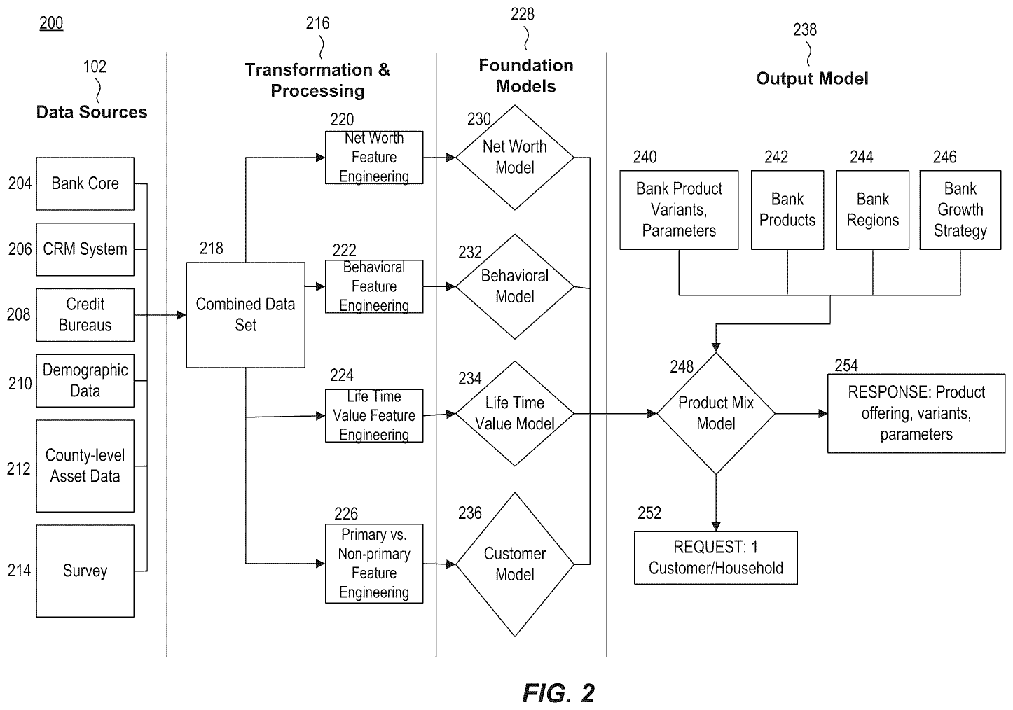

Machine learning algorithm 108 refers to a set of computational procedures and statistical techniques that enable a computer program to learn from and make predictions or decisions based on data. Machine learning algorithm 108 may identify patterns, trends, and relationships within a dataset and use that information to improve performance over time. It is to be appreciated that machine learning algorithm 108 may be one or more machine learning algorithms. The one or more machine learning algorithm may perform tasks simultaneously or sequentially from one another. Machine learning algorithm 108 may include supervised learning algorithms, unsupervised learning algorithms, reinforcement learning algorithms, semi-supervised learning algorithms, and deep learning algorithms. Further, machine learning algorithm 108 may include linear regression, logistic regression, decision trees, random forest, neural networks, or clustering algorithms. In some embodiments, the machine learning algorithm 108 is specialized based on tasks such as classification, regression, clustering, or rule learning. In some embodiments, machine learning algorithm 108 involve natural language processing, speech recognition, image recognition, computer vision, generative models, reinforcement learning, or dimensionality reduction. In some embodiments, the machine learning algorithm 108 may include clustering algorithms for customer segmentation, recommendation systems for suggesting products, and predictive models for forecasting demands. Further, the machine learning algorithm 108 may implement feature engineering, as described below with at least respect to FIG. 2, to select or create relevant features that will be used by the machine learning model 108. In some embodiments, specialized hardware accelerators (e.g., GPUs and TPUs) may be used to enhance machine learning accuracy and performance. The machine learning algorithm 108 may or may not be physically integrated into hardware. Some disclosed embodiments may be software-based and may not require any specified hardware support. In some embodiments, the machine learning algorithm 108 is implemented in software and run on the processing device 122. For example, the machine learning algorithm 108 may be implemented in software (e.g., using Python, R, Java).

In some embodiments, the machine learning algorithm 108 involves training the algorithm on a dataset. Training the machine learning algorithm 108 involves collecting a dataset that includes input features and corresponding target values. The collected dataset may be split into two parts (i.e., a training set and a testing set). The training set may be used to train the model and the testing set may be used to evaluate the model's performance. The machine learning algorithm 108 may make predictions on the training data using the current model parameters. Further, the machine learning algorithm 108 may calculate the loss or error between predicted values and actual target values, where the loss represents how far off the model's predictions are from the true values. In some embodiments, backpropagation may be used to update the model parameters in the direction that reduces loss. Further, an optimization algorithm may minimize the loss by iteratively adjusting the model parameters. For example, during training, the machine learning algorithm 108 may adjust its internal parameters to learn the patterns and relationships between input features and output labels. In some embodiments, training the machine learning algorithm 108 involves iterative optimization and model evaluation. Once the model 108 is trained and validated, it may be used to make predictions or classifications on new, unseen data.

In some embodiments, processing device 122 may extract, using a machine learning algorithm 108, data from data sources 102 or other sources of data (e.g., customer data 104, financial institution data 106). For example, in some embodiments, processing device 122 extracts a plurality of customer behavior features 110 based on the customer data 104. Further, in some embodiments, processing device 122 extracts a plurality of financial institution behavior features 112 based on the financial institution data 106. In some embodiments, the machine learning algorithm 108 is configured to extract customer behavior features 110 and financial institution features 112 by retrieving specific data from a larger dataset or source. For example, machine learning algorithm 108 may be configured to access customer data 104, financial institution data 106 or any other data (e.g., databases, files, APIs, web services) or data source 102. In some embodiments, processing device 122 may establish connections with and retrieve data from customer data 104 and financial institution data 106. Processing device 122 may use software applications or scripts to process and extract relevant information from raw data (e.g., customer data 104, financial institution data 106). For example, processing device 122 may use data extraction scripts, ETL processes, or customized programs to extract information from data (e.g., customer data 104, financial institution data 106). In some embodiments, processing device 122 applies algorithms (e.g., natural language processing, image processing, database queries, data filtering, data aggregation) to extract customer behavior features 110 from customer data 104 and financial institution behavior features 112 from financial institution data 106. In some embodiments, an administrator may determine parameters that cause the machine learning algorithm 108 to extract the data, override the extraction process, or override data that has been extracted. For example, administrator may set parameters that train the machine learning algorithm 108 (e.g., to map the customer data to a customer).

Customer behavior features 110 refer to a system, method, or device related to patterns, actions, or characteristics exhibited by individuals or groups of customers when interacting with products, services, or brands. Non-limiting examples of customer behavior features 110 include purchase history (e.g., frequency, recency, monetary value), browsing behavior (e.g., product views, page visits, time spent), search behavior (e.g., keywords used, filters applied), communication preferences (e.g., preferred channels, opt-in, or opt-out), feedback and reviews (e.g., product reviews), loyalty and retention (e.g., repeat purchases, membership, rewards), customer service interactions (e.g., support tickets, resolution time), demographic information (e.g., age, gender, location), device usage (e.g., device type, operating system), social media engagement (e.g., likes, shares, comments, followers, following), payment preferences (e.g., payment methods, financing options). In some embodiments, customer behavior features 110 may include customer lifetime value, spending patterns, or income levels. Customer behavior features 110 may be stored internally or externally to the processing device 122. For example, customer behavior features 110 may be stored inside processing device in registers or cache. Customer behavior features 110, in some embodiments, may be stored outside of processing device 122 in main memory (e.g., RAM), secondary storage devices (e.g., hard disk drives, solid-state drives), external storage devices (e.g., USB, external hard drives, external solid-state drives), network storage (e.g., remote servers, network-attached storage devices, cloud storage services), or databases. Customer behavior features 110 may be accessible to and communicate with processing device 122, machine learning algorithm 108, trained foundation models 114, trained product model 118 or any other component of system 100. Customer behavior feature data may be stored in databases, data warehouses, web services, files, tables, images, or any other repository that stores data. Some disclosed embodiments may be software-based and may not require any specified hardware support.

Financial institution behavior features 112 refer to a system, method, or device related to patterns, actions, and characteristics exhibited by financial institutions during their operations and interactions with customers, products, services, or brands. Non-limiting examples of financial institution behavior features 112 include transaction volumes (e.g., number of transactions, transaction sizes), financial products offered (e.g., product portfolio), risk management (e.g., credit risk, market risk, operational risk), interest rates (e.g., lending rates, deposit rates), customer acquisition and retention (e.g., customer onboarding, customer retention), compliance and regulatory adherence (e.g., regulatory compliance, audit and reporting), technology adoption (e.g., digital transformation, cybersecurity measures), financial performance (e.g., profitability, asset quality), market presence (e.g., branch network, online and mobile presence), customer service and satisfaction (e.g., service quality, customer satisfaction), innovation and product development (e.g., innovative offerings, research and development), or collaborations and partnerships (e.g., industry collaborations). For example, in some embodiments, financial institution behavior features 112 include one or more of financial preferences or regional characteristics. In some embodiments, financial institution behavior features 112 may be stored inside processing device 122 or outside processing device 122. For example, financial institution behavior features 112 may be stored inside processing device 122 in registers or cache. Customer behavior features 110, in some embodiments may be stored outside of processing device 122 in main memory (e.g., RAM), secondary storage devices (e.g., hard disk drives, solid-state drives), external storage devices (e.g., USB, external hard drives, external solid-state drives), network storage (e.g., remote servers, network-attached storage devices, cloud storage services), or databases. Financial institution features 112 may be accessible to and communicate with processing device 122, machine learning algorithm 108, trained foundation models 114, trained product model 118, or any other component of system 100. Financial institution behavior features data may be stored in databases, data warehouses, web services, files, tables, images, or any other repository that stores data. Some disclosed embodiments may be software-based and may not require any specified hardware support.

Trained foundation models 114 refer to algorithms that have learned patterns, relationships, associations or representations from a data set during a trained process. Trained foundation models 114 may be the outcome of a machine learning process (e.g., machine learning 108 or other machine learning algorithm), where the trained model is a configuration of parameters that has been adjusted to make accurate predictions or decisions. In some embodiments, trained foundation models 114 may be a system, method, or device that has learned patterns, relationships, associations or representations from a data asset during a trained process. Trained foundation models 114 may be trained based on data (e.g., customer data 104, financial institution data, customer behavior features 110, or financial institution features 112). Trained foundation models 114 may communicate with processing device 122, machine learning algorithm 108, databases, or any other component of the system 100. The trained foundation model 114 may or may not be physically integrated into hardware. Some disclosed embodiments may be software-based and may not require any specified hardware support. In some embodiments, the trained foundation model 118 is implemented in software and run on the processing device 122. For example, the trained foundation model may be implemented in software (e.g., using Python, R, Java). In some embodiments, the processing device 122 determines which trained foundation models are implemented and in which order the trained foundation models 114 are implemented, based on the tasks and data. Trained foundation models 114 may be deployed individually, sequentially, in a collection, or ensemble. Further, trained foundation models 114 may act in sequence of each other or work in parallel.

In some embodiments, the trained foundation models 114 are used to make predictions or decisions on new data. By way of non-limiting example, trained foundation models 114 may be logical regression models, random forest models, gradient boosting models, clustering algorithms, or deep learning neural networks. In some embodiments, logistic regression models involve predicting binary outcomes (e.g., whether a customer is likely to purchase or apply for a product or not). Random forest and/or gradient boosting models may involve ensemble modeling and handling complex relationships across input data. Clustering algorithms (e.g., k-means, hbdscan) may involve segmenting customers into similar groups based on behavior, household information, demographic details, hyper-local regions and/or markets. In some embodiments, deep learning or neural networks involve complex nonlinear relationships and specific recommender cases (e.g., identifying a subset of client segments and generating a list of highly likely recommendations specific to region, market leveraging collaborative filtering, content-based filtering, or hybrid approaches). In some embodiments, trained foundation models 114 are used to make predictions, recognize patterns, recognize speech, recognize images, perform natural language processing, make recommendations, detect anomalies, cluster data, make decisions, generate new data, extract features, or reduce dimensionality. Further, trained foundation models 114 may be continuously trained and updated as new data becomes available.

In some embodiments, trained foundation models 114 include a net worth model 230, a behavioral model 232, a life-time value model 234, and a primary vs. non-primary customer model 236 (as described with at least respect to FIG. 2). A net worth model 230 refers to a trained foundational model 114 to assess or predict net worth. For example, a net worth model 230 may involve machine learning algorithm, statistical models, or financial modeling techniques to analyze and predict a customer's or financial institution's net worth based on data (e.g., customer data 104, financial institution data 104). The net worth model 230 may assess or predict net worth based on various factors such as income, expenses, investments, and debts. A behavioral model 232 refers to a trained foundational model 114 that describes the behavior of a system, individual, or entity. For example, a behavioral model 232 may describe the behavior of a customer or financial institution. A life-time value model 234 refers to a trained foundational model 114 that calculates and analyzes the lifetime value of a customer or entity (e.g., financial institution). For example, the life-time value model 234 may describe average purchase value, purchase frequency, or customer life span. The net worth model 230, behavioral model 232, life time value model 234, and primary vs. non-primary customer model 236 may involve data integration, calculation algorithms, segmentation, predictive analysis, visualization, reporting, customization, scalability, and security features.

Trained foundation models 114 output one or more outputs (e.g., foundation model outputs) based on the data inputted into the trained foundation models 114 (e.g., customer behavior features 110, financial institution behavior features 112), selection variables (e.g., foundation model selection variables 116), and the tasks the trained foundation models 114 were configured to perform. Trained foundation models 114 can perform a variety of tasks depending on the type of trained foundation model 114 (e.g., net worth model, behavioral model) or the problem the trained foundation model 114 was trained to solve (e.g., extract, generate, map).

Foundation model selection variables 116 refer to a system, method, or device related to variables used to influence or select which trained foundation models 114 are used or in what sequence the trained foundation models 114 are used in a system (e.g., system 200). It is to be appreciated one or more foundation model selection variables 116 may control one or more trained foundation models 114. In some embodiments, foundation model selection variables 116 may depend on a product portfolio, available data, or market landscape. Further, in some embodiments, foundation model selection variables 116 may include one or more goal inputs 120. In some embodiments, foundation model selection variables 116 include bank product portfolio information, available source data, or market landscape information. The collection or sequence of trained foundation models 114 employed may depend on foundation model selection variables 116 (e.g., product portfolio of bank, available data, market landscape). Foundation model selection variables may be stored in databases, data warehouses, web services, files, tables, images, or any other repository that stores data. It is to be appreciated foundation model selection variables may be one or more foundation model selection variables.

In some embodiments, foundation model selection variables 116 may be stored in a database. Foundation model selection variables 116 may be generated from data sources 102, or inputted by an administrator (e.g., via user interface). Foundation model selection variables 116, in some embodiments, may be configured to be selected by or inputted into processing device 122. The processing device 122 may access, store, retrieve, manipulate, or cause operations due to foundation model selection variables. Additionally, or alternatively, processing device 122, machine learning algorithm 108, or trained foundation models 114 may determine, extract, or store foundation model selection variables based on information from data sources 102 or any other information. For example, processing device 122 may collect information from data sources 102 regarding data (e.g., customer data or financial institution data) which may be used to influence or select which trained foundation models 114 are used or in what sequence the trained foundation models 114 are used. In some embodiments, trained foundation models 114 input foundation model selection variables 116. The trained foundation models 114 may be selected, controlled, or managed based on the foundation model selection variables 116. For example, processing device 122, in some embodiments, may select one or more trained foundation models 114 to be deployed, based on the foundation model selection variables 116.

In some embodiments, trained foundation models 114 are selected in an iterative manner. Various trained foundation model 114 frameworks (e.g., categorical boosting, gradient boosted trees, supervised classification, Bayesian inference, clustering) may be available for each foundation model (e.g., net worth model 230, behavioral model 232, life-time value model 234). The iterative process of selecting the trained foundation models 114, in some embodiments, include finding the best input features and best model framework to achieve the highest accuracy and predictive power while still having a robust model. In some embodiments, trained foundation model 114 performance is assessed via cross-validation or splitting of training and test datasets. It is to be appreciated the best models may differ across client and regional segments. Embodiments of the present disclosure may bring together data sources 102, select and calculate key features for each model type, and iteratively optimize the hyperparameters of the models for the prediction target.

Goal inputs 120 refer to a system, method, or device that provides information related to objectives, aims, or desired results of an individual or entity (e.g., financial institution). For example, goal inputs 120 of a financial institution may involve specific and measurable targets, strategic objectives, financial targets, market share objectives, customer satisfaction goals, or other key performance indicators. Goal inputs 120, in some embodiments, may refer to a combination of product categories and variants that an entity (e.g., financial Institution) aims to recommend or sell. Goal inputs 120, in some embodiments, comprise financial institution products, financial institution product variants, financial institution parameters, financial institution regions, or financial institution growth strategies. Goal inputs 120 may be stored in databases, data warehouses, web services, files, tables, images, or any other repository that stores data. It is to be appreciated goal inputs 120 may be one or more goal inputs.

Financial institution products refer to a system, method, or device that provides information related to financial services and offerings provided by banks, credit unions, insurance companies, investment firms, and other entities operating in the financial sector. For example, financial institution products may include deposit accounts, loans and credit products, investment products, insurance products, wealth management products, payment products, and transactional products. Financial institution products may be stored in databases, data warehouses, web services, files, tables, images, or any other repository that stores data. It is to be appreciated financial institution products may be one or more financial institution products.

Financial institution product variants refer to a system, method, or device that provides information related to different versions or options of financial products offered by financial institutions. Financial institution product variants may be tailored to meet specific needs, preferences, and goals of customer segments. For example, financial institution product variants may involve different interest rates, account minimums, risk levels, overdraft protection, perks, or rewards programs. Financial institution product variants may be stored in databases, data warehouses, web services, files, tables, images, or any other repository that stores data. It is to be appreciated financial institution product variants may be one or more financial institution product variants.

Financial institution parameters refer to a system, method, or device that provides information related to specific features, terms, conditions, and attributes that define the characteristics and functionalities of a particular financial product. For example, financial institution parameters may involve fees and charges, terms and conditions, maturity periods, credit limits, or coverage limits. Financial institution parameters may be stored in databases, data warehouses, web services, files, tables, images, or any other repository that stores data. It is to be appreciated financial institution parameters may be one or more financial institution parameters.

Financial institution regions (e.g., bank regions 244) refer to systems, methods, or devices that provide information related to geographic areas or territories in which a financial institution operates, provides services, and serves its customers. For example, financial institution regions (e.g., bank regions 244) may encompass local, national, or international areas. Financial institution regions (e.g., bank regions 244) may be stored in databases, data warehouses, web services, files, tables, images, or any other repository that stores data. It is to be appreciated financial institution regions may be one or more financial institution regions.

Financial institution growth strategies (e.g., bank growth strategy 246) refer to systems, methods, or devices that provide information related to plans and actions adopted by financial institutions (e.g., banks, credit unions, investment firms) to expand their business, increase market share, and improve overall performance. Financial institution growth strategies (e.g., bank growth strategy 246) may involve customer acquisition and retention, diversification of products and services, digital transformation, market expansion, mergers and acquisitions, partnerships, risk managements, customer relationship management, innovation, product development, or cost management. Financial institution growth strategies (e.g., bank growth strategy 246) may be stored in databases, data warehouses, web services, files, tables, images, or any other repository that stores data. It is to be appreciated financial institution growth strategies may be one or more financial institution growth strategies. Financial institution products, product variants, parameters, and regions, and growth strategies may play a role in determining the scope, reach, and target market of financial institution operations and services.

Goal inputs 120 may be stored in the processing device 122 or separate from the processing device 122. For example, goal inputs 120 may be stored in registers and cache in the processing device 122. Additionally, or alternatively, goal inputs 120 may be stored in a database configured to send information to processing device 122. For example, in some embodiments, processing device 122 may retrieve, generate, or predict goal inputs 120 from data sources 102 or any other source of information. Additionally or alternatively, the trained product model 118 may be configured to input goal inputs 120. Further, in some embodiments, a user, administrator, or entity (e.g., financial institution) can input or manipulate goal inputs 120. For example, an administrator may input goal inputs 120 into a user interface which get stored in a database. Some disclosed embodiments may be software-based and may not require any specified hardware support.

In some embodiments, the processing device 122 is further configured to receive customer feedback through one or more customer feedback channels. Customer feedback channels refer to avenues through which customers, financial institutions, or administrators can provide their opinions, comments, suggestions, or complaints about a product, service, or overall experience. Non-limiting examples of customer feedback channels include surveys, website feedback forms, social media platforms, reviews, rankings, help desks, online communities, forums, complaints, customer service interactions, or online reviews. Customer feedback channels may be configured to input feedback into the processing device 122 or any other component of the system 100 (e.g., data sources, machine learning algorithm 108, trained foundation models 114). In some embodiments, processing device 122 is configured to transform the data from the customer feedback channels to be compatible with the processing device 122 or any other component of the system 100 (e.g., machine learning algorithm 108, trained foundation models 114).

In some embodiments, customers may input customer feedback into customer feedback channels through a user interface (e.g., GUI). Additionally, or alternatively, the processing device 122 may automatically determine customer feedback based on analyzing customer actions, feedback trends, or other ways of analyzing customer sentiment. Customer feedback channels may be incorporated into any stage, component, or operation of the system 100. For example, processing device 122 may receive customer feedback from customer feedback channels, process the feedback, and adjust any part of the system 100 to accommodate the feedback. For example, information from customer feedback channels may adjust goal inputs 120. Additionally or alternatively, customer feedback channels may adjust a trained model (e.g., trained foundation models 114, trained product model 118) based on information from customer feedback channels.

Trained product model 118 refers to an algorithm that has learned patterns, relationships, associations, or representations from a data set during a trained process. In some embodiments, trained product model 118 optimizes the combination of products and services a business offers to customers. Trained product model 118 may provide a strategic approach to managing and optimizing the combination of products or services offered by a company. For example, the output of the trained product model 118 may be an optimized combination of products and services a business offers to its customers. The trained product model 118 may involve decisions about the assortment, pricing, positioning, and promotion of the institution's (e.g., financial institution's) offerings based on goals such as maximizing profitability and meeting customer needs. Trained product model 118, in some embodiments, involves product assortment, product positioning, pricing strategy, product life cycle management, cross-selling, upselling, portfolio analysis, market segmentation, innovation, new product development, profitability analysis, promotion, marketing, or competitive analysis. Trained product model 118 may communicate with processing device 122, machine learning algorithm 108, databases, or any other component of the system 100. The trained product model 118 may or may not be physically integrated into hardware. Some disclosed embodiments may be software-based and may not require any specified hardware support. In some embodiments, the trained product model 118 is implemented in software and run on the processing device 122. For example, the trained product model 118 may be implemented in software (e.g., using Python, R, Java).

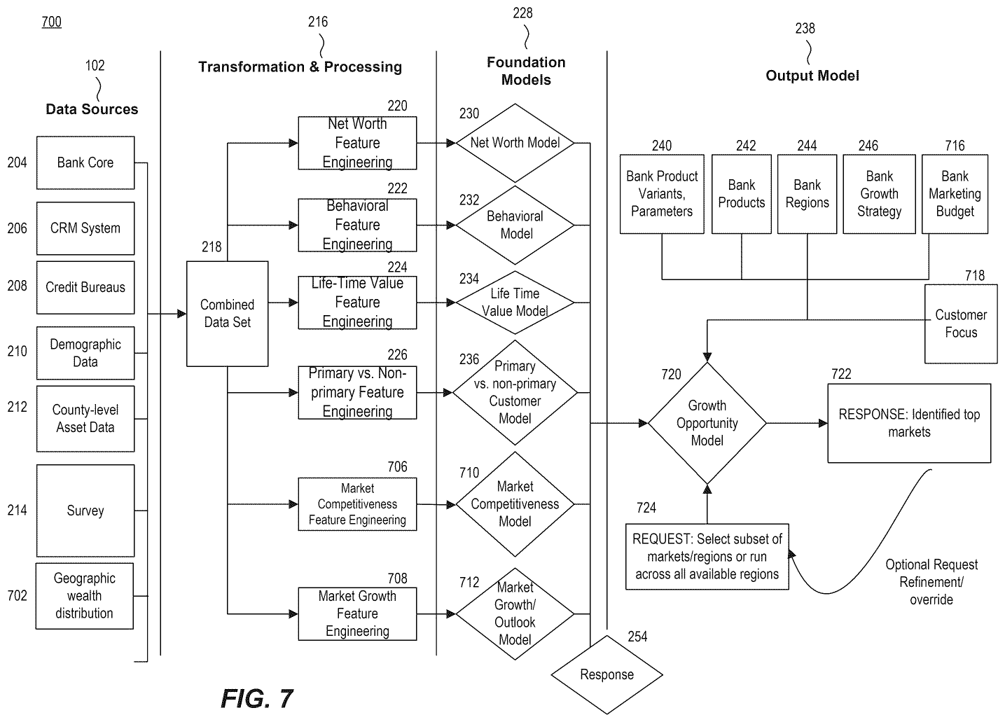

In some embodiments, the trained product model 118 is configured to input foundation model outputs from the trained foundation models 114 and goal inputs 120. For example, the trained product model 118 may output a target product output. Target product output refers to products, variants, and parameters the trained product model 118 outputs. Target product outputs, in some embodiments, are optimized products the financial institution offers based on the information provided to the system 100. In some embodiments, the target product output may be based on a household segment or client segment. It is to be appreciated that the target product output may be sent to another system, device, software application, model, algorithm or any other constituent of a related system or method. For example, the growth opportunity model 720 of FIG. 7 may incorporate the product mix model 248 or input specifically the target product output. Further, it is to be appreciated that in some embodiments, the target product output and product response 254 are synonymous.

Household segment refers to a system, method, or device that provides information related to a specific group or category of households that share similar demographic, socio-economic, or behavioral characteristics. For example, household segmentation may involve dividing the market into distinct segments based on factors such as income, age, family size, lifestyle, geographic location, and purchasing behavior. Household segment data may be stored in databases, data warehouses, web services, files, tables, images, or any other repository that stores data. It is to be appreciated household segment may include one or more household segments.

Client segment refers to a system, method, or device that provides information related to a specific group or category of clients or customers that share common characteristics, needs, or behaviors. For example, client segments may include income level, education, occupation, age, gender, spending patterns, brand loyalty, interests, ethnicity, and values. Client segment data may be stored in databases, data warehouses, web services, files, tables, images, or any other repository that stores data. It is to be appreciated client segment may include one or more client segments. The target product output based on a household segment or a client segment allows businesses and financial institutions to tailor their products, services, and marketing efforts to effectively meet the needs of different groups of customers.

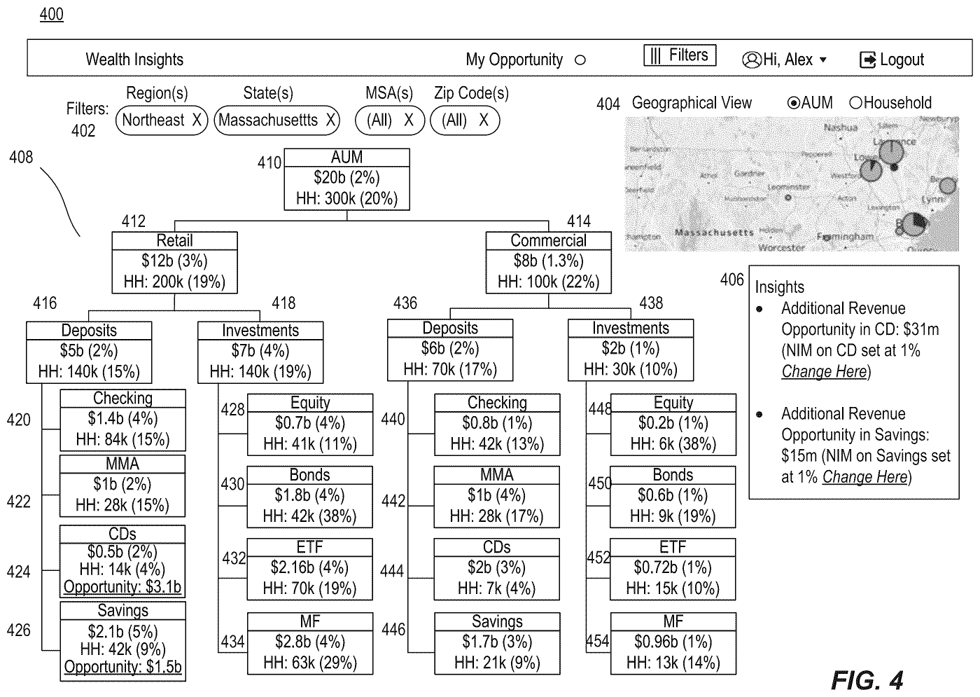

In some embodiments, the target product output comprises a ranking and a likelihood scoring. Ranking refers to an arrangement of items in a specific order based on a particular set of criteria or attributes. For example, the trained product model 118 may generate a ranking of the target product outputs, based on certain criteria such as profitability, sales performance, strategic importance or other relevant metrics. In some embodiments, criteria may be determined by an administrator or goal inputs 120. For example, the trained product model 118 may output target product outputs in a particular order according to the criteria. For example, target product outputs may be ranked from most predicted profit to least predicted profit. Rankings may be displayed in a user interface, as described with at least respect to FIG. 4. For example, the products and product variants with the highest profitability may be ranked higher than the products and variants with lower profitability. Ranking may be stored in databases, data warehouses, web services, files, tables, images, or any other repository that stores data. It is to be appreciated ranking may include one or more rankings. For example, the target product output may be ranked by multiple criteria (e.g., profitability, sales performance).

Likelihood scoring refers to a numerical value or score assigned to target product outputs referring to the probability or likelihood of a particular event, outcome, or occurrence. The trained product model 118 may generate a likelihood scoring based on certain criteria such as profitability. In some embodiments, likelihood scoring may involve risk assessment, predictive analytics, and decision-making to quantify the probability of a specific event or condition taking place based on data, historical trends, or models. For example, products and product variants with a higher probability of success may have a greater likelihood score than products and variants with a lower probability of success. Likelihood scoring may be stored in databases, data warehouses, web services, files, tables, images, or any other repository that stores data. It is to be appreciated likelihood scoring may include one or more likelihood scores. In some embodiments, likelihood scoring may be in addition to ranking.

In some embodiments, processing device 122 is further configured for filtering data. Processing device 122 may filter data using algorithms or logic implemented in software to selectively include or exclude data based on specific criteria. Filtering data is especially important for refining datasets, extracting relevant information, or preparing data for further analysis. In some embodiments, machine learning algorithm 108, trained foundation models 114, trained product model 118, or other components of the system 100 may be configured for filtering data. Non-limiting examples of filtering include collaborative filtering, content-based filtering, or hybrid recommendation filtering. Collaborative filtering refers to a technique used to provide personalized suggestions or recommendations to the trained product model 118 based on preferences and behaviors of users or components. For example, the trained product model 118 may learn patterns and similarities from historical interactions and leverage that knowledge to predict how a customer, financial institution, or component may interact with items they have not yet encountered. Collaborative filtering may involve memory-based collaborative filtering (e.g., customer-based collaborative filtering, product-based collaborative filtering) or model-based collaborative filtering.

Content-based filtering refers to a technique that utilizes the characteristics or features of items (e.g., products) and preferences of users (e.g., customers, financial institutions) to make personalized recommendations. For example, with content-based filtering, the trained product model 118 may analyze the features of items that a user (e.g., customer, financial institution) has interacted with or liked and recommends items (e.g., products, product variants) with similar characteristics. Content-based filtering may involve feature extraction, user profile creation, similarity calculations, rankings, recommendations, feedback, and iterations.

Hybrid recommendation filtering involves combining multiple recommendation techniques or models to enhance the accuracy and effectiveness of the system 100. For example, hybrid recommendation filtering may leverage the strengths of different recommendation methods to overcome individual methods' limitations. Hybrid recommendation filtering may be a weighted hybrid, switching hybrid, or feature combination hybrid system. For example, hybrid recommendation filtering may combine multiple recommendation techniques such as content-based and collaborative filtering methods to provide more accurate and personalized recommendations. Non-limiting examples of additional filtering methods include contextual filtering, demographic filtering, popularity filtering, dynamic filtering, constraint filtering, exclusion filtering, feedback-driven filtering.

In some embodiments, the processing device 122 is configured to monitor the trained product model's 118 performance. For example, the processing device 122 may monitor the trained product model 118 performance by assessing the trained product model's 118 accuracy, reliability, or effectiveness over time. Monitoring the trained product model 118 performance may involve defining evaluation metrics (e.g., accuracy, precision, recall, mean squared error), evaluating test data, cross-validation, tracking model inputs, or any other way of tracking performance. In some embodiments, the processing device 122 may monitor one or more trained product model 118 metrics at predetermined times. Trained product model 118 metrics refer to quantitative measures used to assess the performance and effectiveness of the trained product model. The trained product model metrics may depend on the nature of the problem (e.g., classification, regression) and the goals of the trained product model. Non-limiting examples of trained product model metrics include accuracy, precision, recall, F1 score, area under ROC curve, mean absolute error, mean squared error, R-squared, mean absolute percentage error. In some embodiments, the processing device 122 monitors the trained product model metrics at predetermined times. Predetermined times refers to established or fixed points in time that have been decided or set in advance. In some embodiments, predetermined times are based on a schedule or plan. For example, monitoring trained product model metrics may involve a task scheduler, batch processing, real-time clock, or logging. In some embodiments, user, administrator, or processing device 122 may determine, control, and manipulate trained product model 118 metrics of interest and predetermined times. It is to be appreciated processing device 122 may also monitor other components of the system 100, such as customer data 104, financial institution data 106, machine learning algorithm 108, customer behavior features 110, financial institution behavior features 112, trained foundation models 114, foundation model selection variables 116, goal inputs 120, or data sources 102.

In some embodiments, the processing device 122 is configured to refine the machine learning algorithm 108, trained foundation models 114, and trained product model 118. For example, the trained product model 118 may be refined according to the performance of the trained product model 118. In some embodiments, refining the trained product model 118 involves improving the trained product model's 118 performance, accuracy, or generalization by making adjustments or optimizations. For example, processing device 122 may adjust the trained product model's 118 parameters to address issues identified during evaluation or incorporate new data to enhance the trained product model's 118 capabilities. Refining the trained product model 118 may involve hyperparameter tuning, feature engineering, data augmentation, regularization, ensemble methods, cross-validation, transfer learning, error analysis, or updating the training data. It is to be appreciated the processing device 122 may be configured to refine any of the components of system 100.

In some embodiments, the processing device 122 is configured to update data sources 102, databases, customer data 104, financial institution data 106, or any other source of information. Updates may involve modifying the data stored in databases, memory, or other storage medium to reflect changes, corrections, or additions. Processing device 122 may update data automatically or at predetermined times. In some embodiments, processing device 122 may update data (e.g., customer data 104) by retrieving instructions from memory, decoding the instructions, executing the operation from the decoded instructions, updating the data by writing memory, registers, or other data storing components.

In some embodiments, the system 100 further comprises feedback loops. Feedback loops involve iterative updates and changes of data and systems. For example, feedback loops may allow processing device 122 to update customer data 104, financial institution data 106, machine learning algorithm 108, customer behavior features 110, financial institution behavior features 112, trained foundation models 114, foundation model selection variables 116, trained product model 118, goal inputs 120, target product output, or any other component of system 100. Further, feedback loops may feed an output of the system 100 into the system 100 as an input, creating a cycle of self-regulation or adaption. For example, if new source data becomes available or conditions of system 100 change, the processing device 122 may adjust accordingly. In some embodiments, the processing device 122 continuously monitors data sources 102 and compares source data to customer data 104 and financial institution data 106. If the processing device 122 determines the source data is different than the customer data 104 or financial institution data 106, feedback loops may update customer data 104, financial institution data 106, and system 100 accordingly. It is to be appreciated feedback loops may be implemented between any two variables, structures, components, outputs, or other part of the system 100. Feedback loops maintain and enhance quality, functionality, and user experience over time. For example, feedback loops may facilitate refined learning of machine learning models 108, training of trained foundation models 114, or optimization of trained product model 118. In some embodiments, the system 100 may include one or more interconnected feedback loops. Further, feedback loops may be parallel feedback loops or nested feedback loops.

In some embodiments, the processing device 122 provides updated customer data 104 to the machine learning algorithm 108 through a first feedback loop. The processing device 122 may modify the system 100, including the customer behavior features 110 and foundation model outputs based on information received from the first feedback loop to refine the machine learning algorithm 108.

In some embodiments, the processing device 122 provides updated financial institution data to the machine learning algorithm through a second feedback loop. The processing device 122 may modify the financial institution behavior features 112 and foundation model outputs based on information received from the second feedback loop to refine the machine learning algorithm 108.

In further embodiments, the processing device 122 updates goal inputs 120 at predetermined times, provides the updated goal inputs 120 to the trained product model 118 in a third feedback loop, and trains the trained product model 118 based on information received from the third feedback loop to refine the trained product model 118.

In further embodiments, system 100 may include a user interface. User interface refers to a point of interaction between a user and a computer system or software application. For example, the user interface may be a graphical user interface (GUI), command-line interface (CLI), touchscreen interface, or web user interface. For example, in some embodiments, a user may input information into the system 100 using a user interface and the processing device 122 may process the user input. In some embodiments, the user interface may be configured to display the target product output, rankings, and likelihood scoring.

FIG. 2 depicts an exemplary system architecture diagram 200 for optimizing the combination of products and services a business offers to customers, consistent with disclosed embodiments. For example, system architecture diagram 200 provides a high-level view of FIG. 1, where the output of system 200 includes a response with a product offering, product variants, and parameters. Specifically, system architecture diagram 200 comprises multiple stages including data sources 102, transformation and processing 216, foundation models 228, and output model 238. In some embodiments, the data sources stage 102 feeds into the transformation and processing stage 216, which feeds into the foundation models stage 228, which feeds into the output model. Each stage (e.g., data sources 102, transformation and processing 216, foundation models 228, output model 238) may be or include a system, method, or device.

Data sources 102 refers to any system, device, or application that produces or provides data, as described elsewhere herein with respect to at least FIG. 1. Non-limiting examples of data sources 102 include databases, data warehouses, sensors, web services, files, images, Application Programming Interfaces (APIs), or any other repository that produces or provides data. As shown, data sources 102 may include bank core system 204, CRM system 206, credit bureau system 208, demographic data system 210, county-level asset data system 212, federal reserve consumer survey 214, or any other source of information. Data sources 102 may input data into the transformation and processing stage 216. As described elsewhere herein with respect to at least FIG. 1, data sources 102 refer to any system, device, or application that produces or provides data.

Transformation and processing 216, in some embodiments, refers to a system, method, or device that comprises a combined data set 218, and feature engineering systems (e.g., net worth feature engineering 220, behavioral feature engineering 222, life-time value feature engineering 224, primary vs. non-primary feature engineering 226). Combined data set 218 refers to a single dataset or database that is created by merging or concatenating two or more datasets or data sources 102. The combined data set 218 may integrate multiple sources into a unified dataset, providing a more comprehensive and holistic view of the data. For example, in machine learning, combined datasets may be used for training models on diverse data sources to improve performance. In some embodiments, combined data set 218 includes assets and liabilities data. In some embodiments, the combined data set 218 may input, extract, or retrieve data from one or more data sources 102 (e.g., bank core system, CRM system). In some embodiments, the combined data set 218 may transform data into a format compatible with feature engineering systems (e.g., net worth feature engineering 220, behavioral feature engineering 222, life-time value feature engineering 224, primary vs. non-primary feature engineering 226). Further, the combined data set 218 may output transformed data to feature engineering systems (e.g., net worth feature engineering 220, behavioral feature engineering 222, life time value feature engineering 224, primary vs. non-primary feature engineering 226).

Feature engineering determines features, such as calculated or combined attributes in raw input data (e.g., data from combined data set 218), which provide greater predictive power of the target output (e.g., target product output). For example, feature engineering refers to systems, methods, or devices that use machine learning to create new features or modify existing features to improve the performance of models (e.g., foundation models 228 or output model 238). For example, feature engineering may enhance the models' (e.g., foundation models 228 or output model 238) ability to learn patterns and make accurate predictions. In some embodiments, feature engineering may involve selecting, transforming, and creating features based on knowledge and insights gained from the data. It is to be appreciated that every feature engineering model, process, or pipeline (e.g., net worth feature engineering 220, behavioral feature engineering 222, life time value feature engineering 224, primary vs. non-primary feature engineering 226) is different because each feature engineering model is optimized for its own downstream foundation model (e.g., net worth model 230, behavioral model 232, life time value model 234, primary vs. non-primary customer model 236, respectively). For example, feature engineering may involve understanding a dataset (e.g., combined dataset 218), identifying a target variable, conducting exploratory data analysis, encoding categorical variables, creating interaction terms, scaling features, extracting relevant information from data, applying transformations, reducing dimensionality, regularizing data, and monitoring the impact of feature engineering on model (e.g., foundation models 228 or output model 236) performance. Further, in some embodiments, feature engineering may involve resolving missed values or outliers in the data. It is to be appreciated feature engineering models function to fine-tune, preprocess, or optimize the downstream model (e.g., net worth model 230, behavioral model 232, life time value model 234, primary vs. non-primary customer model 236).

In some embodiments, each feature engineering model (e.g., net worth feature engineering 220, behavioral feature engineering 222, life-time value feature engineering 224, primary vs. non-primary feature engineering 226) identifies the best available data set to predict a target, given the information it was given. For example, the data subset generated by the feature engineering model (e.g., net worth feature engineering 220, behavioral feature engineering 222, life time value feature engineering 224, primary vs. non-primary feature engineering 226) may have a reduced data set with the most relevant features (e.g., data attributes). In some embodiments, feature engineering models (e.g., net worth feature engineering 220, behavioral feature engineering 222, life-time value feature engineering 224, primary vs. non-primary feature engineering 226) also consider time frames such as balances over period of time (e.g., 3, 12 months), loan payoff behavior, savings and spending behavior. In some embodiments, each feature engineering model (e.g., net worth feature engineering 220, behavioral feature engineering 222, life time value feature engineering 224, primary vs. non-primary feature engineering 226) may include a feedback loop to further optimize the downstream model (e.g., net worth model 230, behavioral model 232, life time value model 234, primary vs. non-primary customer model 236). It is to be appreciated additional feature engineering models may be added or removed from system 200, according to corresponding foundation models 228. For example, if an additional foundation model 228 is added to the system 200, an additional corresponding feature engineering model may be added to the system 200.

The feature engineering blocks may output a modified dataset with new features or transformed versions of existing features. The output of the feature engineering blocks depends on the operations performed during feature engineering. For example, feature engineering outputs may include modified datasets, new features, transformed features, interaction terms, encoded categorical variables, binned or discretized features, selected features, dimensionality-reduced features, or cleaned data.

Foundation models 228 refer to a system, method, or device that has learned patterns, relationships, associations or representations from a data set during a trained process, as described elsewhere herein with respect to at least FIG. 1. Trained models may be the outcome of a machine learning process, where the trained model is a configuration of parameters that has been adjusted to make accurate predictions or decisions. In some embodiments, foundation models refer to large-scale, pre-trained models that serve as the basis or starting point for downstream tasks. For example, foundation models 228 may include a net worth model 230, a behavioral model 232, a life-time value model 234, or a primary vs. non-primary customer model 236.

Net worth model 230 refers to a system, method, or device designed to estimate an individual's or entity's net worth. In some embodiments, net worth model 230 involves machine learning algorithm. Key components and considerations of the net worth model 230 include assets (e.g., investments, real estate, bank core, CRM system, county-level assets), liabilities (e.g., debt, bank core, credit bureau, county-level liabilities), income (e.g., salary), expenses (e.g., housing, insurance), savings and investments (e.g., emergency fund, investment portfolio), credit (e.g., credit score, credit utilization), financial goals, demographics, economic factors, or external or public proxies (e.g., demographic data, federal reserve survey, wealth distribution). In some embodiments, the net worth model 230 involves categorical boosting (catboost) or gradient boosted trees (xgboost) for regression targets.

In some embodiments, the net worth model 230 is associated with a feature engineering model (e.g., net worth feature engineering 220). The feature engineering model (e.g., net worth feature engineering 220) identifies the best set of raw data and calculated data attributes for a region and household to leverage for net worth estimation. For example, in some instances, retirement assets and county-level assets may be relied upon to estimate the net worth for a requested household or median net worth for a zip+4 area. A zip+4 area refers to an extended zip code, where an additional four digits is added to a basic five-digit zip code to provide further detail of a geographic area and thus improve accuracy. In other embodiments, bank and wealth management information is selected to estimate net worth for a requested household or median net worth for a zip+4 area. In some embodiments, net worth model 230 outputs a net worth range of a given household based on a household address or zip code. It is to be appreciated the net worth model 230 may output any other information related to the inputs of the net worth model 230. In addition to the raw attributes, net worth feature engineering 220 and net worth model 230 may estimate time windows, medians, averages, and combinations across data sets. For example, net worth feature engineering 220 may generate a “savings-spending” rate over 3 months vs. 12 months. The “savings-spending” rate may involve a ratio or percentage that reflects the proportion of income allocated to savings compared to spending.

Behavioral model 232 refers to a system, method, or device that designed to understand and predict the behavior of individuals or entities in financial decision-making processes. For example, behavioral model 232 may involve spending patterns, saving habits, or investment choices. Further, behavioral model 232 may take into account psychological factors, decision-making processes, heuristics, biases, social influences, cultural influences, or market dynamics. In some embodiments, behavioral model 232 outputs a likelihood of category of client relationship and classification of a top category. For example, the behavioral model 232 may output a percentage likelihood of each category of client relationship. It is to be appreciated the behavioral model 232 may output any other information related to the inputs of the behavioral model 232. Key components and considerations of the behavioral model 232 include assets (e.g., bank core, CRM system, county-level assets), liability data (e.g., bank core, credit bureau, county-level liabilities), or external or public proxies (e.g., demographic data, federal reserve survey, wealth distribution). In some embodiments, the behavioral model 232 involves supervised classification algorithms or Bayesian interference frameworks to estimate the likelihood of each category.

In some embodiments, the behavioral model 232 is associated with a feature engineering model (e.g., behavioral feature engineering 222). The feature engineering model (e.g., behavioral feature engineering 222) identifies the best set of raw and calculated data attributes for a region and household to understand customer behavior with regards to spending, savings, investments, loyalty, and engagement. In one embodiment, customer behavior is categorized into various buckets such as active savers, active spenders, wealth accumulators, wealth investors, deposits only, certificate of deposit only, inactive, or dormant. In addition to the raw attributes, feature engineering model (e.g., behavioral model 232) may estimate time windows, medians, averages, and combinations across data sets. For example, feature engineering model (e.g., behavioral feature engineering 232) may generate a “savings-spending” rate over 3 months vs. 12 months.

Life-time value model 234 refers to a refers to a system, method, or device that predicts total revenue an entity (e.g., financial institution) can reasonably expect to earn from a customer over the course of their entire relationship. Key considerations of a life-time value model 234 include average purchase value, purchase frequency, customer lifespan, retention rate, gross margin, discount rate, or customer acquisition cost. The life-time value model 234 may output information such as a life-time value estimate. It is to be appreciated the life-time value model 234 may output any other information related to the inputs of the life-time value model 234. Key components and considerations of the life-time value model 234 include assets (e.g., bank core, CRM system, county-level assets), liability data (e.g., bank core, credit bureau, county-level liabilities), or external or public proxies (e.g., demographic data, federal reserve survey, wealth distribution). In some embodiments, the life-time value model 234 involves clustering (e.g., buckets of customers), regression models or RFM (i.e., recency, frequency, monetary value).

In some embodiments, the life-time value model 234 is associated with a feature engineering model (e.g., life-time value feature engineering 224). The feature engineering model (e.g., life-time value feature engineering 224) identifies the best set of raw and calculated data attributes for a region and household to estimate lifetime value of a customer. In addition to the raw attributes, feature engineering model (e.g., life-time value feature engineering 224) may estimate time windows, medians, averages, and combinations across data sets. For example, feature engineering model (e.g., life-time value feature engineering 224) may generate a “savings-spending” rate over 3 months vs. 12 months.

Primary vs. non-primary customer model 236 refers to a system, method, or device that determines if a customer is a primary bank customer or non-primary bank customer. For example, primary customer refers to the main or core customer group for a business (e.g., financial institution). In contrast, non-primary customer refers to customer segments that are not the main focus of a business (e.g., financial institution) or that contribute a smaller portion of revenue compared to primary customers. In some embodiments, the primary vs. non-primary customer model outputs information based on customer groups (e.g., primary customer, non-primary customer). It is to be appreciated what is considered a primary or non-primary customer may evolve based on shifting business strategies, market dynamics, and changes in customer behavior. In some embodiments, the primary vs. non-primary customer model 236 outputs a classification if a customer is a primary bank customer (e.g., received paycheck, main debit/credit cards) vs. non-primary (e.g., may just have CD, savings, investment account, dormant checking, dormant savings). Key components and considerations of the life-time value model 234 include assets (e.g., bank core, CRM system, county-level assets), liability data (e.g., bank core, credit bureau, county-level liabilities), or external or public proxies (e.g., demographic data, federal reserve survey, wealth distribution). In some embodiments, the primary vs. non-primary customer model 236 involves a xgboost classification (e.g., binary classification).

In some embodiments, the primary vs. non-primary customer model 236 is associated with a feature engineering model (e.g., primary vs. non-primary feature engineering model 226). The feature engineering model (e.g., primary vs. non-primary feature engineering model 226) identifies the best set of raw and calculated data attributes to identify if a customer has a primary relationship with a financial institution. For example, the feature engineering model (e.g., primary vs. non-primary feature engineering model 226) may identify if a customer conducts their everyday banking needs with the financial institution. In addition to the raw attributes, feature engineering model (e.g., primary vs. non-primary feature engineering 226) may estimate time windows, medians, averages, and combinations across data sets. For example, feature engineering model (e.g., primary vs. non-primary feature engineering 226) may generate a “savings-spending” rate over 3 months vs. 12 months.

Foundation models 228 (e.g., net worth model 228, behavioral model 230) may receive or input data or outputs from feature engineering systems (e.g., net worth feature engineering 220, behavioral feature engineering 222, life time value feature engineering 224, primary vs. non-primary feature engineering 226). For example, net worth feature engineering 220 may output insights of a customer's financial situation. By way of non-limiting example, net worth feature engineering 220 may output income features (e.g., monthly income, income sources), expense features (e.g., monthly expenses), asset features (e.g., real estate value, investment portfolio), liability features (e.g., debt amount, debt-to-asset ratio), savings and investments (e.g., investment types), credit history (e.g., credit score, credit utilization), demographic features (e.g., age, career, education level), financial goals (e.g., savings goals, investment strategies), net worth behavioral features (e.g., spending patterns, saving habits), or derived ratios (e.g., net worth growth rate, investment return ratios). In some embodiments, the net worth model 230 may input or retrieve the output of net worth feature engineering 220, so that net worth model 230 can estimate an individual or entity's net worth.

Similarly, in one embodiment, behavioral feature engineering 222 may output insights of customers' or entities' (e.g., financial institutions) financial decision making. By way of non-limiting example, behavioral feature engineering 222 may output transaction history, spending patterns, income information, savings, investment behavior, credit score, credit history, demographic information, market trends, or social influences. In some embodiments, behavioral model 232 may input or retrieve the output of behavioral feature engineering 222, so that the behavioral model 232 can estimate an individual or entity's financial behaviors, preferences, and decision-making patterns.

Life-time value feature engineering 224, in some embodiments, output insights of total value a customer is expected to generate for a business over the duration of their relationship. By way of non-limiting example, life-time value feature engineering 224 may output historical purchase data, average purchase value, customer acquisition cost, customer churn rate, average customer lifespan, customer segmentation, customer demographics, or customer support interactions. In some embodiments, life-time value model 234 may input or retrieve the output of life-time value feature engineering 224, so that the life time value model 234 can estimate the total value a customer is expected to generate for a business over the duration of their relationship.

Primary vs. non-primary feature engineering 226 may output insights of the total value a customer is expected to generate for a business over the duration of their relationship. By way of non-limiting example, primary vs. non-primary feature engineering 226 may output historical purchase data, average purchase data, customer acquisition cost, retention rate, customer churn rate, or average life span information. In some embodiments, primary vs. non-primary customer model 236 may input or retrieve the output of primary vs. non-primary feature engineering 226, so that the primary vs. non-primary customer model 236 can estimate the total value a customer group is expected to generate for a business over the entire duration of their relationship. It is to be appreciated any foundation model (e.g., net worth model 230, behavioral model 232, life time value model 234, primary vs. non-primary customer model 236) may retrieve data from any feature engineering model (e.g., net worth feature engineering 220, behavioral feature engineering 222, life-time value feature engineering 224, primary vs. non-primary feature engineering 226).

The output model 238 refers to a system, method, or device that may receive, input, or extract information from the foundation models 228. In some embodiments, the output model includes bank product variants and parameters 240, bank products 242, bank regions 244, bank growth strategy 246, a product mix model 248, a request 252, and a product response 254. Bank product variants and parameters 240, bank products 242, bank regions 244, bank growth strategy 246, product mix model 248, request 252, and product response 254 may be systems, methods, devices, or other sources of information. In some embodiments, the product mix model 248 is a strategic model that involves determining the combination or assortment of products or services that a company will offer to its customers. In some embodiments, the product mix model 248 is a machine learning algorithm used to optimize and manage a product portfolio. The product mix model 248 optimizes the product portfolio to meet customer needs, maximize revenue, and achieve overall business objectives. In some embodiments, the product mix model 248 refers to a system, method, or device that includes product portfolio, product differentiation, market segmentation, market demand, profitability analysis, product life cycle, cross-selling, competitive landscape, resource allocation, strategic objective, adaptability, diversification, and customer feedback information. Some disclosed embodiments may be software-based and may not require any specified hardware support.

In some embodiments, the product mix model 248 inputs, receives, or extracts goal inputs 120. In some embodiments, goal inputs 120 may be stored in databases. By way of non-limiting example, goal inputs 120 involve bank product variants and parameters 240, bank products 242, bank regions 244, and bank growth strategy 246. In some embodiments, the bank product variants and parameters 240, bank products 242, bank regions 244, and bank growth strategy 246 may be inputted into the product mix model 248. Bank product variants and parameters 240, bank products 242, bank regions 244, bank growth strategy 246, product mix model 248, request 252, and product response 254 may be systems, methods, devices, or other sources of information. It is to be appreciated that although the goal inputs 120 in the exemplary output model 238 refer to banks, goal inputs may also be targeted to any other financial institution such as commercial banks, investment banks, credit unions, savings and loan associations (S&Ls), insurance companies, brokerage firms, pension funds, hedge funds, private equity firms, or central banks. Further, goal inputs 120 may involve one specific financial institution (e.g., JPMorgan Chase), a category of financial institutions (e.g., commercial banks), or any other group of financial institutions. For example, in some embodiments, goal inputs 120 may include hedge fund product variants and parameters 240, hedge fund products 240, hedge fund region 244, and hedge fund growth strategy 246.

Bank products 242 refers to any system, method, device, or information related to products or services a financial institution offers. For example, bank products 242 may include savings accounts, checking accounts, certificates of deposit, money market accounts, personal loans, auto loans, mortgages, credit cards, home equity loans, business loans, lines of credit, investment products, online banking, mobile banking, ATM services, wire transfers, safe deposit boxes, financial advisory services, insurance products, or student loans. Bank products 242 may be stored in databases, data warehouses, web services, files, tables, images, or any other repository that stores data. It is to be appreciated bank products 242 may include one or more bank products.

Bank product variants 240 refer to any system, method, device, or information related to different versions or iterations of financial products and services that financial institutions offer. For example, bank product variants 240 may include savings account variants (e.g., basic savings account, high-interest savings account, joint savings account), checking account variants (e.g., basic checking account, interest-bearing checking account, premium checking account), loan variants (e.g., fixed rate loans, adjustable-rate loans, secured loans, unsecured loans), credit card variants (e.g., standard credit card, rewards credit card, secured credit card), mortgage variants (e.g., fixed rate mortgage, adjustable-rate mortgage, government-backed mortgage), investment product variants (e.g., individual retirement accounts, brokerage accounts), digital banking variants (e.g., online banking, mobile banking), insurance product variants (e.g., whole life insurance, term life insurance, variable life insurance), or loan product variants (e.g., auto loans, personal loans). Bank product variants 240, in some embodiments, involve distinct features, terms, or conditions which allow customers to choose the option that best aligns with their financial goals and requirements. Bank product variants 240 may be stored in databases, data warehouses, web services, files, tables, images, or any other repository that stores data. It is to be appreciated bank product variants 240 may include one or more bank product variants.

Bank regions 244 refer to any system, method, device, or information related to geographic areas or locations where a financial institution operates and provides its products and services. For example, for multinational banks, bank regions 244 may involve divisions in different continents or major economic zones. Bank regions 244 may be stored in databases, data warehouses, web services, files, tables, images, or any other repository that stores data. It is to be appreciated bank regions 244 may include one or more bank regions.

Bank growth strategy 246 refers to any system, method, device, or information related to growth and expansion strategies to expand market presence of a financial institution. Non-limiting examples of bank growth strategy 246 involve market penetration, product diversification, geographic expansion, digital transformation, mergers and acquisitions (M&As), and cross selling. Bank growth strategy 246 may be stored in databases, data warehouses, web services, files, tables, images, or any other repository that stores data. It is to be appreciated bank growth strategy 246 may include one or more bank growth strategies.

In some embodiments, the product mix model 248 may be configured to input goal inputs (e.g., bank products 242, bank regions 244). It is to be appreciated one or more of the goal inputs 120 may be input into the product mix model 248 at the same time or simultaneously. Further, the processing device 122, trained product model 118, or any other component or algorithm may control which goal inputs 120 are input into the product mix model 248, when they are input into the product mix model 248, and in what order they are input into the product mix model 248. Further, a user, administrator, or financial institution may adjust, add, and manipulate the goal inputs 120.

In some embodiments, the product mix model 248 is configured to input a request 252. In some embodiments, the request 252 is a customer or household segment. Customer segments refer to any system, method, device, or information related to groups of individuals or entities that share common characteristics and needs, making them a distinct and identifiable market segment for a company's products or services. Including customer segment information into the product mix model 248 allows for a more accurate output, customized to a particular group within the overall market. Customer segments may involve demographic segmentation (e.g., age, gender, income, education, occupation), geographic segmentation (e.g., country, region, city), psychographic segmentation (e.g., lifestyle, values, interests), behavioral segmentation (e.g., purchasing patterns, product usage, brand loyalty, response to marketing initiatives), business-to-business segmentation (e.g., industry, size, revenue), channel preference segmentation (e.g., online, in-store, mobile), or usage segmentation (e.g., frequency of using product). Customer segments may be stored in databases, data warehouses, web services, files, tables, images, or any other repository that stores data. It is to be appreciated customer segments may include one or more customer segments.

Household segments refer to any system, method, device, or information related to distinct groups or categories of households that share common characteristics, needs, or behaviors. Household segments may involve demographic segments (e.g., family size, age of household members), income-based segments (e.g., income levels, disposable income), geographic segments (e.g., urban, suburban, rural), lifestyle segments (e.g., tech-savvy, luxury), behavioral segments (e.g., buying behavior, product usage), household composition segments (e.g., single households, multi-generational households), technology adoption segments (e.g., tech-savvy households, traditional households), and financial behavior segments (e.g., savers, spenders, investment preferences). Users, administrators, financial institutions may input (e.g., via user interface) and manipulate request 252 (e.g., client and household segment information). Household segments may be stored in databases, data warehouses, web services, files, tables, images, or any other repository that stores data. It is to be appreciated household segments may include one or more household segments. In some embodiments, the trained foundation models 114 retrieve, extract, gather, or input request 252 (e.g., client and household segment) to product mix model 248. It should be understood that one or more requests 252 (e.g., customer segments, one or more household segments, or both customer segments and household segments) may be input into the product mix model 248.

The product mix model 248 refers to a system, method, or device that may output a response based on the inputs of the product mix model 248. For example, the product mix model 248 may optimize the product portfolio to meet customer needs, maximize revenue, and achieve overall business objectives. Further, the product mix model 248 may output product response 254 including a product offering, product variants, and parameters based on the request 242 and goal inputs 120. For example, the product response 254 may be an optimal product and variants for a particular customer segment. In some embodiments, the product response 254 includes a product offering, variants, parameters, a ranking, and a likelihood scoring. The product response 254, in some embodiments, is displayed on a user interface.

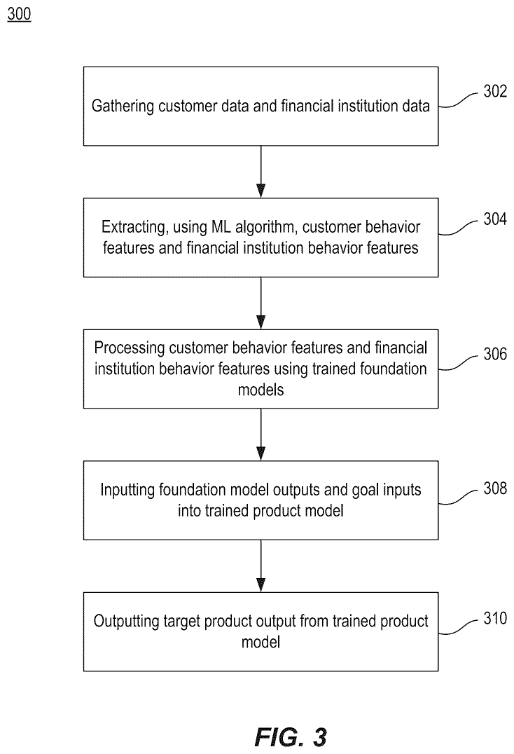

FIG. 3 depicts an exemplary method 300 for optimizing the combination of products and services a business offers to customers, consistent with disclosed embodiments. The method 300 comprises: gathering customer data 104 and financial institution data 106 in step 302, extracting customer behavior features 110 and financial institution behavior features 112 using a machine learning algorithm 108 in step 304, processing the customer behavior features 110 and financial institution behavior features 112 using trained foundation models 114 in step 306, inputting the foundation model outputs and goal inputs 120 into the trained product model 118 in step 308, and outputting the target product output from the trained product model 118 in step 310.

In step 302, processing device 122 gathers customer data 104 and financial institution data 106. Customer data 104 refers to information regarding current customers, previous customers, potential customers, or anyone or entity (e.g., financial institution) that may be considered of interest for data collection. For example, in some embodiments, customer data 104 may include customer profiles, transaction history, demographics, economic indicators, household assets, or credit reports. Financial institution data 106 refers to information regarding the financial industry, such as banking and investing data. For example, financial institution data 106 may include risk management data (e.g., credit risk data, fraud detection data), operational data (e.g., transaction processing data, customer service records), regulatory and compliance data, market and economic data (e.g., interest rates, market indices, economic indicators), investment data (e.g., portfolio information, market research), or insurance data (e.g., policyholder information, claims data). In some embodiments, the processing device 122 may gather customer data 104 and financial institution data 106 from data sources 102. The processing device 122 may gather customer data 104 and financial institution data 106 by connecting to external devices, storage systems, or networks to retrieve information. For example, the processing device 122 may gather data from input devices, through a network, or through a bus system. For example, the processing device 122 may gather customer data 102 and financial institution data 106 from data sources 102, remote servers, databases, or any other storage mechanism through network interfaces (e.g., Ethernet, Wi-Fi).

In step 304, the processing device 122 may extract, using machine learning algorithm 108 customer behavior features 110 and financial institution behavior features 112. Customer behavior features 110 refer to patterns, actions, or characteristics exhibited by individuals or groups of customers when interacting with products, services, or brands. Financial institution behavior features 112 refer to patterns, actions, and characteristics exhibited by financial institutions in the course of their operations and interactions within the financial industry. In some embodiments, the processing device 122 uses software applications or scripts to process and extract relevant information from data (e.g., customer data 104, financial institution data 106). For example, the processing device 122 may use data extraction scripts, ETL processes, or customized programs to extract information from data (e.g., customer data 104, financial institution data 106). In some embodiments, the processing device 122 may apply algorithms (e.g., natural language processing, image processing, database queries, data filtering, data aggregation) to extract customer behavior features 110 from customer data 104 and financial institution behavior features 112 from financial institution data 106.

In step 306, the processing device 122 may process customer behavior features 110 and financial institution behavior features 112 using the trained foundation models 114. The trained foundation models 114 refer to machine learning algorithms that have undergone a training process using training data to learn patterns and relationships within the data. In some embodiments, the trained foundation models 114 are used to make predictions or decisions on new data. In some embodiments, trained foundation models 114 include a net worth model, a behavioral model, a life-time value model, and a primary vs. non-primary customer model (as described with at least respect to FIG. 2).

In step 308, the processing device 122 inputs foundation model outputs and goal inputs 120 into the trained product model 118. The trained product model 118 refers to an algorithm that has learned patterns, relationships, associations, or representations from a data set during a trained process. In some embodiments, the trained product model 118 is a product mix model. The output of the trained product model 118 depends on the foundation model outputs and the goal inputs 120.

In step 310, the processing device 122 outputs the target product output from the trained product model 118. The target product output refers to products, variants, and parameters the trained product model 118 outputs. Target product outputs, in some embodiments, are optimized products the financial institution offers based on the information provided to the system 100 and according to the way the machine learning algorithm 108, trained foundation models 114, and trained product model 118 are trained. For example, in one embodiment, the target product output may be optimized product and product variants according for a customer segment and according to the strategic objectives of a consumer bank. In some embodiments, the target product output may be displayed on a user interface.

FIG. 4 displays an exemplary user interface 400, consistent with disclosed embodiments. The user interface 400 is a point of interaction between a user or administrator and system 100. For example, the user interface 400 may be a graphical user interface (GUI) including icons, buttons, menus, and windows that allow a user to interact with system 100. In some embodiments, the user interface 400 displays the target product output of system 100 (as shown in FIG. 1). In some embodiments, the user interface 400 comprises a filter selection panel 402, a geographical view map 404, an insights panel 406, and a product opportunity display 408. The user interface 400 may be configured to communicate with the processing device 122 and provide information to the processing device 122, for example using client-server architecture. Further, the user interface 400 may be configured to communicate with APIs, HTTP, Asynchronous JavaScript, WebSocket, use backend processing, and be accessible through web applications. In some embodiments, the filter selection panel 402 displays filters that the user has defined (e.g., regions, states, MSAs, zip codes). The user may delete or change the selections in the filter selection panel 402. Accordingly, the user interface 400 may update according to the filter selections. In some embodiments, the geographical view 404 displays a map of the designated regions of interest (e.g., regions selected in the filter selection panel 402). In some embodiments, the geographical view 404 displays icons representing product opportunities and regions of interest. The user may manipulate the geographical view 404, for example by zooming in and zooming out, selecting the icons to display additional information, and filtering what icons are shown (e.g., AUM, household). In some embodiments, the insights panel 406 displays additional revenue opportunities. For example, the insights panel 406 may display additional revenue opportunities in savings, as well as details related to the additional revenue opportunity (e.g., associated value of the additional revenue opportunity). In some embodiments, the product opportunity display 408 is configured to display assets under management (AUM) information 410, including the total market value of assets that a financial institution, investment company, or individual manages and the associated product opportunities. In FIG. 4, an AUM tree is depicted, where an exemplary financial institution's business is broken out in a simple tree diagram. In some embodiments, AUM may be divided into a retail segment 412 and a commercial segment 414. The retail segment 412 involves providing financial services directly to individual customers. For example, the retail segment 412 may involve savings accounts, checking accounts, personal loans, mortgages, credit cards, and other financial products tailored for individual customers. The commercial segment 414 involves providing financial services directly to businesses, governments, or other large institutions. For example, the commercial segment 414 may involve business loans, checking accounts, savings accounts, credit lines, treasury services, merchant services, overdraft protection, cash management services, or business credit cards. In some embodiments, the retail segment 412 and commercial segment are divided into deposit categories (e.g., deposit category 416, deposit category 436) and investment categories (e.g., investment category 418, investment category 438). The deposit categories (e.g., deposit category 416, deposit category 436) may be further divided into product offerings. In some embodiments, product offerings involve bank products 242 (as shown in FIG. 2). By way of non-limiting example, the deposit category 416 includes a checking block 420, a money market account (MMA) block 422, a certificates of deposit (CDs) block 424, and a savings block 426. In some embodiments, each block (e.g., AUM block 410, deposits block 416, checking block 420, MMA block 422) displays the AUM number and number of households (HH) in that specific subsegment of a financial institution. In some embodiments, the AUM number and number of households in a subsegment may be shown as a percentage of the overall market captured (e.g., 17%). The investment categories (e.g., investment category 418, investment category 438) may be further divided into product offerings. In some embodiments, product offerings involve bank products 242 (as shown in FIG. 2). By way of non-limiting example, the investment category 418 includes an equity block 428, a bonds block 430, an Exchange-Traded Fund (ETF) block 432, and a mutual fund (MF) block 434. In some embodiments, each block (e.g., checking block 420, MMA block 422, equity block 428) displays a product opportunity and predicted amount of associated growth (e.g., in currency and percentage growth).

In some embodiments, the user interface 400 may be configured for a user to select configurable filters. For example, the user interface 400 may include a pop-up filter window where the user selects a region of interest (e.g., Northeast, Midwest, South, West, or All Regions), select a state of interest (e.g., Massachusetts, Alabama, Alaska, Delaware, or all states), select a metropolitan statistical area (MSA) (e.g., New York-Newark-New Jersey, Los Angeles-Long Beach, or all MSAs), or select a zip code of interest (e.g., 10100, 10101, or all). The user interface 400 may update the information displayed based on the user's selected filters. Further, the filter selection panel 402 may display the user selected filters.

In some embodiments, the user may select a block of the product opportunity display 408 to show more detailed information or further configure the system 100. For example, the user may select the CDs block 424. It is to be appreciated user interface 400 may also be configured to display information related to identified combination of top markets a business offers to customers for growth opportunities.

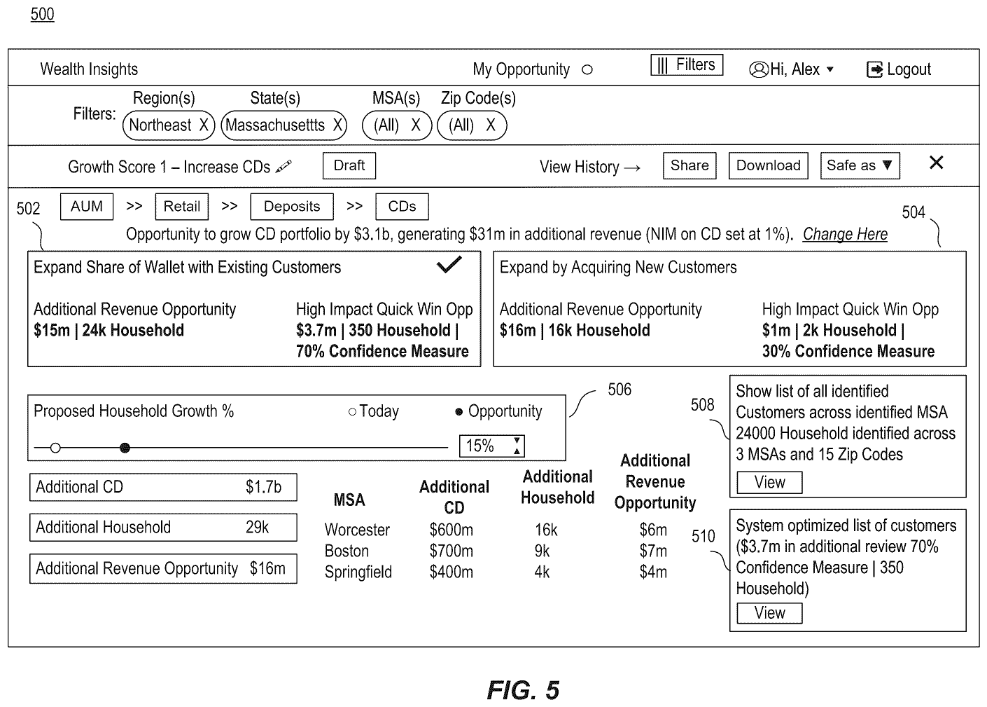

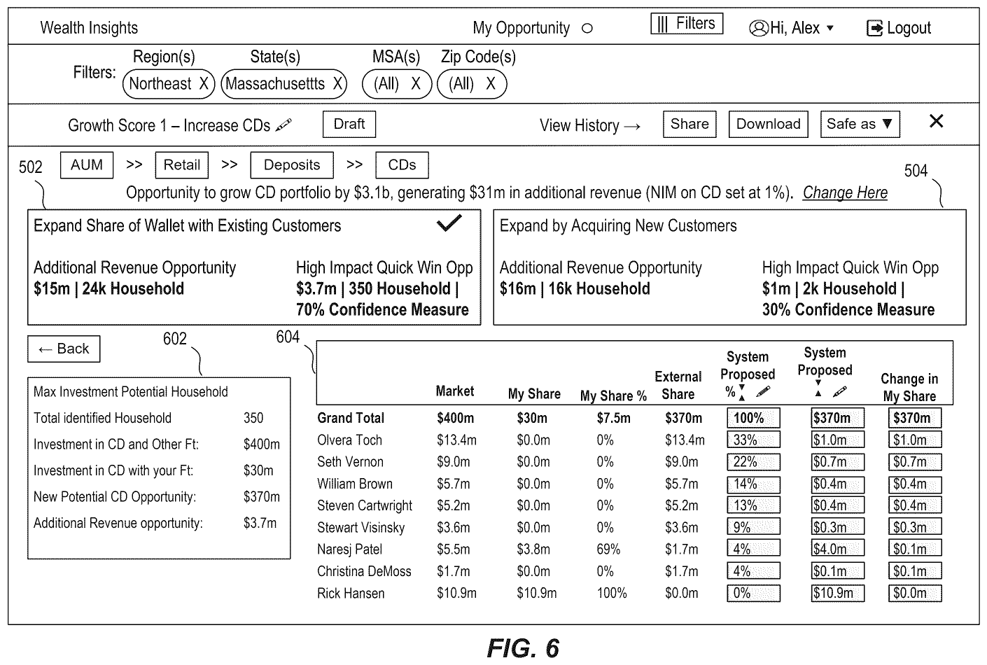

FIG. 5 is a third exemplary user interface 500 displaying detailed product opportunity information. As shown in FIG. 5, the user interface 500 may display more details for the selected CDs growth opportunity. In some embodiments, the user may select options such as an expand share of wallet with existing customers panel 502 and an expand by acquiring new customers panel 506. Based on the selected panel (e.g., expand share of wallet with existing customers panel 502, expand by acquiring new customers panel 506), the user interface 500 may display additional details about the product opportunity such as proposed household growth percentage growth 506, and additional revenue opportunities according to location (e.g., Worcester, Boston, Springfield). The user interface 500, in some embodiments, displays quantitative measurements of additional product opportunities (e.g., additional CD, additional household, additional revenue opportunity). Further, in some embodiments, the user interface 500 may include options to show a list of all identified customers across a segment 508 and a system optimized list of customers 510. In some embodiments, the list of all identified customers across a segment 508 or system optimized list of customers 510 can be displayed on the user interface 500 (as shown in FIG. 6).

For example, in FIG. 6, the user interface 500 includes a maximum investment potential panel 602 and list of all identified customers across a segment 604. The maximum investment potential panel 602 includes information such as the number of total identified items in a segment (e.g., total number of households) and quantitative values associated with investment opportunities (e.g., a new potential CD opportunity). Further, in some embodiments, the list of all identified customers across a segment 508 may include associated details such as the total market, a customer's share (i.e., in currency, in percentage), the external share, the system proposed share (i.e., in currency, in percentage), and the change in share (i.e., in currency, in percentage) of the product opportunity. In some embodiments, the user has the ability to override the system proposed share (i.e., in currency, in percentage).

In some embodiments, the user interface 500 may be configured to allow users to share the product opportunity strategies with users, administrators, financial institutions, existing customers, new customers, or any other individual or entity. In some embodiments, the users may select the method of sharing the growth strategy (e.g., email, text, cloud-based software system, SaaS platform, or other software systems). It is to be appreciated user interface 400 may also be configured to display information related to identifying combination of top markets a business offers to customers for growth opportunities.

FIG. 7 depicts an exemplary system architecture diagram for identifying a combination of top markets a business offers to customers in order to highlight potential growth opportunities. System 700 may be used independent from or in conjunction to system 200 and system 800. Similar to System 200, System 700 comprises multiple stages including data sources 102, transformation and processing 216, foundation models 228, and output model 238. In some embodiments, the data sources stage 102 feeds into the transformation and processing stage 216, which feeds into the foundation models stage 228, which then feeds into the output model. It is to be appreciated each stage of system 700 (e.g., data sources 102, transformation and processing 216) may occur in a different order than depicted in FIG. 7. Further, it is to be appreciated components of each stage (e.g., data sources 102, transformation and processing 216) shown in FIG. 7 may be different in other embodiments. For example, in another embodiment, combined data set 218 may be part of the data sources 102 stage. Each stage (e.g., data sources 102, transformation and processing 216, foundation models 228, output model 238) may be or include systems, methods, or devices.

As described with at least respect to FIG. 1, data sources 102 refers to any system, device, or application that produces or provides data. Non-limiting examples of data sources 102 include databases, data warehouses, sensors, web services, files, images, Application Programming Interfaces (APIs), or any other repository that produces or provides data. As shown, data sources 102 may include bank core system 204, CRM system 206, credit bureau system 208, demographic data system 210, county-level asset data system 212, federal reserve consumer survey 214, geographic wealth distribution system 702, or any other source of information. Data sources 102 may input data into the transformation and processing stage 216.

Geographic wealth distribution system 702 refers to refers to a system, method, or device that provides information regarding the way total wealth is spread or allocated among individuals, households, nations, regions or entities. Global wealth distribution system 702 may provide information regarding the distribution of financial and non-financial assets, including real estate, investments, and other forms of wealth across different regions and demographic groups (e.g., countries, states, cities, neighborhoods). Further, in some embodiments, global wealth distribution system 702 provides information related to the patterns of ownership, income, and financial well-being across different regions and demographics. In some embodiments, global wealth distribution system 702 provides information regarding income inequality, wealth disparities, regional disparities, economic development, urban-rural divide, infrastructure, investment patterns, government policies, quality of life, access to financial resources, economic policies, global economic trends, global financial systems, societal factors, or cultural factors among households and individuals. Global wealth distribution system information may be stored in databases, data warehouses, web services, files, tables, images, or any other repository that stores data. It is to be appreciated global wealth distribution system 702 may include one or more global wealth distribution systems.

Transformation and processing 216, in some embodiments, comprises a combined data set 218, and feature engineering systems (e.g., net worth feature engineering 220, behavioral feature engineering 222, life-time value feature engineering 224, primary vs. non-primary feature engineering 226, market competitiveness feature engineering 706, market growth feature engineering 708). Combined data set 218 refers to a single dataset or database that is created by merging or concatenating two or more datasets or data sources 102. The combined data set 218 may integrate multiple sources into a unified dataset, providing a more comprehensive and holistic view of the data. In some embodiments, the combined data set 218 may transform data into a format compatible with feature engineering systems (e.g., net worth feature engineering 220, behavioral feature engineering 222, life-time value feature engineering 224, primary vs. non-primary feature engineering 226, market competitiveness feature engineering 706, market growth feature engineering 708). Further, the combined data set 218 may output transformed data to feature engineering systems (e.g., net worth feature engineering 220, behavioral feature engineering 222, life-time value feature engineering 224, primary vs. non-primary feature engineering 226, market competitiveness feature engineering 706, market growth feature engineering 708).

As described elsewhere herein with respect to at least FIG. 2, feature engineering systems (e.g., net worth feature engineering 220, behavioral feature engineering 222, life-time value feature engineering 224, primary vs. non-primary feature engineering 226, market competitiveness feature engineering 706, market growth feature engineering 708) determine features, such as calculated or combined attributes in raw input data (e.g., data from combined data set 218), which provide greater predictive power of the target output (e.g., target market output, response). For example, feature engineering refers to systems, methods, or devices that use machine learning to create new features or modify existing features to improve the performance of models (e.g., foundation models 228 or output model 238). Feature engineering, in some embodiments, identifies the best set of raw and calculated data attributes to quantify or score the competitiveness of financial institutions (e.g., banks) or local markets (e.g., at zip+4, county, or state levels). For example, feature engineering may enhance the models' (e.g., foundation models 228 or output model 238) ability to learn patterns and make accurate predictions. It is to be appreciated that every feature engineering model, process, or pipeline (e.g., net worth feature engineering 220, behavioral feature engineering 222, life time value feature engineering 224, primary vs. non-primary feature engineering 226, market competitiveness feature engineering 706, market growth feature engineering 708) is different because each feature engineering model is optimized for its own downstream foundation model (e.g., net worth model 230, behavioral model 232, life time value model 234, primary vs. non-primary customer model 236, market competitiveness feature engineering 706, market growth feature engineering 708, respectively). For example, feature engineering may involve understanding a dataset (e.g., combined dataset 218), identifying a target variable, conducting exploratory data analysis, encoding categorical variables, creating interaction terms, scaling features, extracting relevant information from data, applying transformations, reducing dimensionality, regularizing data, and monitoring the impact of feature engineering on model (e.g., foundation models 228, output model 236) performance. Further, in some embodiments, feature engineering may involve resolving missed values or outliers in the data. It is to be appreciated feature engineering functions to fine-tune, preprocess, or optimize the downstream model (e.g., net worth model 230, behavioral model 232, life time value model 234, primary vs. non-primary customer model 236, market competitiveness feature engineering 706, market growth feature engineering 708, respectively).

In some embodiments, each feature engineering model (e.g., net worth feature engineering 220, behavioral feature engineering 222, life time value feature engineering 224, primary vs. non-primary feature engineering 226, market competitiveness feature engineering 706, market growth feature engineering 708) identifies the best available data set to predict a target, given the information it was given. For example, the data subset generated by feature engineering model (e.g., net worth feature engineering 220, behavioral feature engineering 222, life time value feature engineering 224, primary vs. non-primary feature engineering 226, market competitiveness feature engineering 706, market growth feature engineering 708) may have a reduced data set with the most relevant features (e.g., data attributes). In some embodiments, feature engineering models (e.g., net worth feature engineering 220, behavioral feature engineering 222, life-time value feature engineering 224, primary vs. non-primary feature engineering 226, market competitiveness feature engineering 706, market growth feature engineering 708) also consider time frames such as balances over period of time (e.g., 3, 12 months), loan payoff behavior, savings and spending behavior. In some embodiments, each feature engineering system (e.g., net worth feature engineering 220, behavioral feature engineering 222, life time value feature engineering 224, primary vs. non-primary feature engineering 226, market competitiveness feature engineering 706, market growth feature engineering 708) may include a feedback loop to further optimize the downstream model (e.g., net worth model 230, behavioral model 232, life time value model 234, primary vs. non-primary customer model 236, market competitiveness model 710, market growth/outlook model 712, respectively). It is to be appreciated additional feature engineering models may be added or removed from system 700, according to corresponding foundation models 228. For example, if an additional foundation model 228 is added to the system 700, an additional corresponding feature engineering model may be added to the system 700. Further, feature engineering system (e.g., net worth feature engineering 220, behavioral feature engineering 222, life time value feature engineering 224, primary vs. non-primary feature engineering 226, market competitiveness feature engineering 706, market growth feature engineering 708) does not necessarily need to be independent from one another. For example, in some embodiments, there may be one large feature engineering system which serves the purpose of the independent feature engineering systems shown in FIG. 7 (e.g., net worth feature engineering 220, behavioral feature engineering 222, life time value feature engineering 224, primary vs. non-primary feature engineering 226, market competitiveness feature engineering 706, market growth feature engineering 708).

Feature engineering (e.g., net worth feature engineering 220, behavioral feature engineering 222, life time value feature engineering 224, primary vs. non-primary feature engineering 226, market competitiveness feature engineering 706, market growth feature engineering 708) may each output a modified dataset with new features or transformed versions of existing features. The output of the feature engineering models depends on the operations performed during feature engineering. For example, feature engineering outputs may include modified datasets, new features, transformed features, interaction terms, encoded categorical variables, binned or discretized features, selected features, dimensionality-reduced features, or cleaned data based on the function of the feature engineering block.

Foundation models 228 refer to algorithms that have learned patterns, relationships, associations or representations from a data set during a trained process, as described elsewhere herein with respect to at least FIG. 1. Trained models may be the outcome of a machine learning process, where the trained model is a configuration of parameters that has been adjusted to make accurate predictions or decisions. In some embodiments, foundation models 228 may incorporate feature engineering. In some embodiments, foundation models 238 refer to large-scale, pre-trained models that serve as the basis or starting point for downstream tasks. For example, foundation models 228 may include a net worth model 230, a behavioral model 232, a life-time value model 234, a primary vs. non-primary customer model 236, a market competitiveness model 710, or a market growth/outlook model 712. Each foundation model 228 (net worth model 230, a behavioral model 232, a life-time value model 234, a primary vs. non-primary customer model 236, a market competitiveness model 710, or a market growth/outlook model 712) may input information from a feature engineering model (e.g., net worth feature engineering 220, behavioral feature engineering 222, life time value feature engineering 224, primary vs. non-primary feature engineering 226, market competitiveness feature engineering 706, market growth feature engineering 708) or also perform operations of the feature engineering models. Market competitiveness model 710 refers to a system, method, device, or framework used to assess the level of competition within a specific financial market. In some embodiments, market competitiveness model 710 may include information related to the dynamics, structure, and competitive factors in a given market. Market competitiveness model 710, in some embodiments, includes information about investment decisions, pricing strategies, and regulatory considerations. Non-limiting examples of information included in market competitiveness model 710 include market structure, product differentiation, market share concentration, regulatory environment, customer switching costs, market trends, or market forces. Market competitiveness model data may be stored in databases, data warehouses, web services, files, tables, images, or any other repository that stores data. Key components and considerations of the market competitiveness model 710 include assets (e.g., investments, real estate, bank core, CRM system, county-level assets), liabilities (e.g., debt, bank core, credit bureau, county-level liabilities), income (e.g., salary), expenses (e.g., housing, insurance), savings and investments (e.g., emergency fund, investment portfolio), credit (e.g., credit score, credit utilization), financial goals, demographics, economic factors, external or public proxies (e.g., demographic data, federal reserve survey, wealth distribution), competitor information (e.g., banks active in region, market penetration), hyper-local traffic data, business activity, bank branches. In some embodiments, market competitiveness model 710 outputs a scoring from 0-100 of hyper-local market (e.g., 0 being the least competitive and 100 being the most competitive) for a product or product category. In addition to the raw attributes, market competitiveness feature engineering 706 and market competitiveness model 710 may estimate time windows, medians, averages, and combinations across data sets. For example, market competitiveness feature engineering 706 may generate information related to number of banks active/closed, branches open/closed, and digital bank offerings over 3 months vs. 12 months. It is to be appreciated the market competitiveness model 710 may output any other information related to the inputs of the market competitiveness model 710. In some embodiments, the market competitiveness model 710 involves statistical models or muti-variate regression models to achieve scores based on multiple features or inputs.

Market growth/outlook model 712 refers to a system, method, or device used to assess the anticipated growth trajectory and future prospects of a specific financial market. In some embodiments, market growth/outlook model 712 provides information related to potential trends, opportunities, and challenges that may impact a market in the future. Market growth/outlook model 712 may also project future performance of markets. Non-limiting examples of information included in market growth/outlook model 712 includes market historical performance, economic indicators (e.g., GDP growth, inflation rates, interest rates), market size, market potential, demographic trends, regulatory landscape, competitive analysis, global trends, regional trends, investor sentiment, or market risks. Market growth/outlook model data may be stored in databases, data warehouses, web services, files, tables, images, or any other repository that stores data. Key components and considerations of the market growth/outlook model 712 include assets (e.g., investments, real estate, bank core, CRM system, county-level assets), liabilities (e.g., debt, bank core, credit bureau, county-level liabilities), income (e.g., salary), expenses (e.g., housing, insurance), savings and investments (e.g., emergency fund, investment portfolio), credit (e.g., credit score, credit utilization), financial goals, demographics, economic factors, external or public proxies (e.g., demographic data, federal reserve survey, wealth distribution), competitor information (e.g., banks active in region, market penetration), hyper-local traffic data, business activity, bank branches. In some embodiments, market growth/outlook model 712 outputs a product-level, category level, or bank level growth in percent over 3 months vs. 12 months. It is to be appreciated the market growth/outlook model 712 may output any other information related to the inputs of the growth/outlook model 712. In addition to the raw attributes, market growth feature engineering 708 and market growth/outlook model 712 may estimate time windows, medians, averages, and combinations across data sets. For example, market growth feature engineering 708 may generate information related to number of banks active/closed, branches open/closed, and digital bank offerings over 3 months vs. 12 months. In some embodiments, the market growth/outlook model 712 involves statistical models, muti-variate regression models, or prophet models (e.g., metal machine learning forecasting model) to forecasts or growth rates.

The output model 238 is a system, method, or device that may receive, input, or extract information from the foundation models 228 or other source of information. In some embodiments, the output model 238 includes bank product variants and parameters 240, bank products 242, bank regions 244, bank growth strategy 246, a request 754, a product response 254, a bank marketing budget 716, or a customer focus 718. In some embodiments, the growth opportunity model 720 is a strategic system that involves identifying a combination of top markets a business offers to customers for growth opportunities. In some embodiments, the growth opportunity model 720 is a machine learning algorithm used to identify top markets in a region. The growth opportunity model 720 identifies top markets to optimize a financial institution's product portfolio to meet customer needs, maximize revenue, and achieve overall business objectives. In some embodiments, the growth opportunity model 720 is a system or device which includes information related to market analysis, customer segmentation, competitive landscape, technological trend, financial analysis, strategic alliance, global expansion, risk assessment, scalability, and long-term vision information. Some disclosed embodiments may be software-based and may not require any specified hardware support.

In some embodiments, the growth opportunity model 720 inputs, receives, or extracts goal inputs 120. In some embodiments, goal inputs 120 may be stored in databases, data warehouses, web services, files, tables, images, or any other repository that stores data. By way of non-limiting example, goal inputs 120 involve bank product variants and parameters 240, bank products 242, bank regions 244, bank growth strategy 246, bank marketing budget 716, customer focus 718, or product response 254. In some embodiments, the bank product variants and parameters 240, bank products 242, bank regions 244, bank growth strategy 246, bank marketing budget 716, customer focus 718, and product response 254 may be inputted into the growth opportunity model 720. It is to be appreciated that although the goal inputs 120 in the exemplary output model 238 refer to banks, goal inputs may also be targeted to any other financial institution such as commercial banks, investment banks, credit unions, savings and loan associations (S&Ls), insurance companies, brokerage firms, pension funds, hedge funds, private equity firms, or central banks.

In some embodiments, the growth opportunity model 720 is configured to input a request 724. In some embodiments, the request 724 is a system, method, or device related to a select subset of markets or regions. Request 724 may input information or data into growth opportunity model 720. In some embodiments, the request 724 is run across a subset of markets or regions or across all available regions. Inputting subsets of markets or regions into the growth opportunity model 720 allows for a more accurate growth opportunity model 720 output, customized to a particular region within the overall market. Market regions may be at many different levels, for example a zip+4 level). Market subsets or regions may be stored in databases, data warehouses, web services, files, tables, images, or any other repository that stores data. It is to be appreciated market regions may include one or more market regions.

Bank marketing budget 716 refers a system, method, or device related to the allocated financial resources that a bank sets aside for its marketing activities and initiatives. In some embodiments, bank marketing budget 716 refers to the amount of money a bank plans to spend on various marketing strategies and campaigns within a specific period (e.g., fiscal year). Non-limiting examples of information included in bank marketing budget 716 include strategic objectives, campaigns, initiatives, marketing channels, marketing platforms, market research, branding, positioning, and contingency planning. Bank marketing budget 716 may be stored in databases, data warehouses, web services, files, tables, images, or any other repository that stores data. It is to be appreciated bank marketing budget may include one or more bank marketing budgets.

Customer focus 718 refers to a system, method, or device related to a financial institution's focus on prioritizing or targeting the needs of customers who are already established clients (e.g., existing customers) or allocating resources to attract and acquire new customers. In some embodiments, customer focus 718 includes information related to customer retention, cross selling, customer feedback, marketing campaigns, promotions, incentives, or market expansion. Customer focus 718 may be stored in databases, data warehouses, web services, files, tables, images, or any other repository that stores data. It is to be appreciated customer focus may include one or more customer focuses.

The growth opportunity model 720 may output a market response 722 based on the inputs of the growth opportunity model 720. For example, the growth opportunity model 720 may identify a combination of top markets a business offers to customers for growth opportunities to meet customer needs, maximize revenue, and achieve overall business objectives. Further, the growth opportunity model 720 may output market response 722 including top market for a MSA or zip+1 level. The growth opportunity model 720 may further depend on product offering, product variants, and parameters based on the request 724 and other goal inputs 120. For example, the market response 722 may be a top market given for a particular region (e.g., zip+4 code). In some embodiments, the market response 722 includes a ranking, and a likelihood scoring. The market response 722, in some embodiments, is displayed on a user interface.

Product response 254 refers to a system, method, or device related to the target product output of FIG. 1 or product response 254 or FIG. 2. Response, in some embodiments, are optimized products the financial institution offers based on the information provided to the system 700 and according to the way the feature engineering models, foundation models 228, and trained product model 118 are trained. In some embodiments, product response 254 may not be the output of product mix model 248, but rather any output that includes information about a financial institution's product offerings, product variants, or product parameters. For example, in one embodiment, the market response 722 may be a list of optimized product and product variants for a customer segment and according to the strategic objectives of a consumer bank.

In some embodiments, market response 722 includes a customer list or a household list of optimized products, product variants, or product parameters. A customer list refers to a contemplation or database of names or contact information of individuals or entities that engage with businesses (e.g., financial institution) by making purchases, using services, or establishing a relationship. Customer list may be stored in databases, data warehouses, web services, files, tables, images, or any other repository that stores data. It is to be appreciated customer list may be one or more customer lists. A household list refers to a compilation or database containing information about financial aspects of a household. Non-limiting examples of household list include details about income, expenses, assets, liabilities, budgeting information, financial goals, investment portfolio, and other financial information related to a household. Household list may be stored in databases, data warehouses, web services, files, tables, images, or any other repository that stores data. It is to be appreciated household list may be one or more household lists. In some embodiments, the customer list or household list includes product or product parameter information. Further, market response 722 may be sent to or input to another model (e.g., campaign execution model 812), system, method, device, algorithm, method or source of information.

In some embodiments, system 700 further comprises feedback loops. Feedback loops involve iterative updates and changes of data and systems. For example, feedback loops may allow processing device 122 to update input data 102, transformation and processing 216, foundation models 228, and output model 238. Further, feedback loops may feed an output of the system 700 (e.g., market response 722) into the system 700 as an input, creating a cycle of self-regulation or adaption. For example, if new input data 102 becomes available or conditions of system 700 change, the processing device 122 may adjust accordingly. It is to be appreciated feedback loops may be implemented between any two variables, structures, components, devices, outputs, or other part of the system 700. Feedback loops maintain and enhance quality, functionality, and user experience over time. For example, in some embodiments, processing device 122 may update request 724 (e.g., market segment and regional segment) at predetermined times. Processing device 122, in some embodiments, may provide updated request 724 (e.g., market segment and regional segment data) to the trained growth opportunity model 720 in a fourth feedback loop.

Further, the processing device 122 may train the trained growth opportunity model 720 based upon information received from the fourth feedback loop to refine the trained growth opportunity model 720. In some embodiments, feedback loops may fine-tune growth opportunity model 720 at different levels (e.g., the household level). Feedback loops may allow administrator or processing device 122 to review mapping of the growth opportunity model 720. Further, feedback loops may allow administrator or processing device 122 to include or exclude customers, regions, or products in the growth opportunity model 720. Feedback loops, in some embodiments, allow administrator or processing device 122 to include or exclude existing or new customers in the growth opportunity model 720. In some embodiments, feedback loops allow administrators or processing device 122 override request 724 or any information or configuration of the growth opportunity model 720. In some embodiments, the system 700 may include one or more interconnected feedback loops. Further, feedback loops may be parallel feedback loops or nested feedback loops.

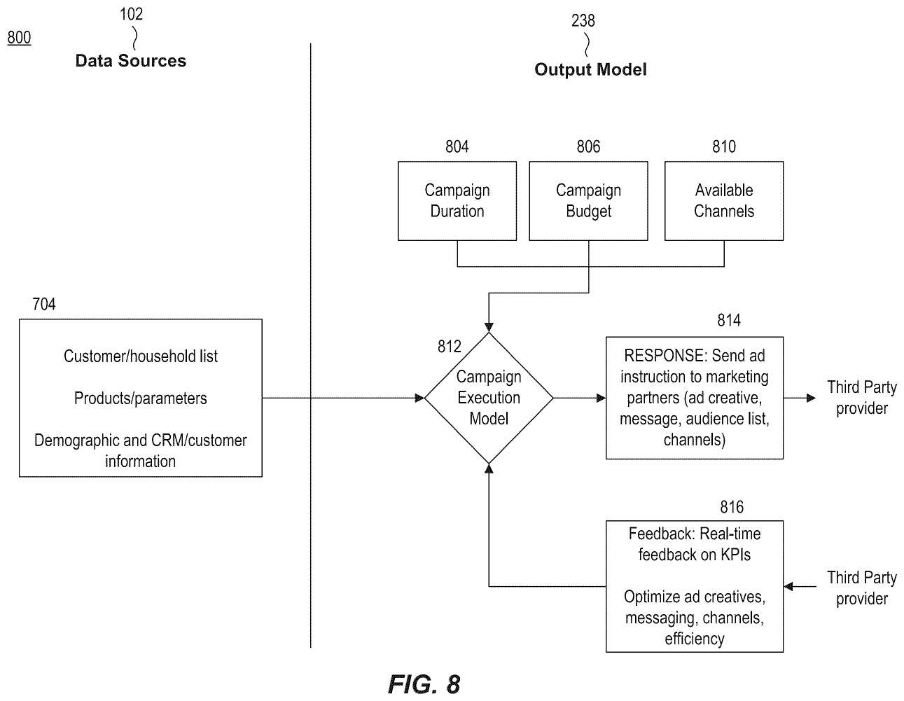

FIG. 8 depicts an exemplary system architecture diagram for optimizing advisements using machine learning. System 800 may be used independent from or in conjunction to system 200 and system 700. Similar to system 200 and system 700, system 800 comprises multiple stages including data sources 102 and output model 238. It is to be appreciated that although FIG. 8 does not depict transformation and processing 216 and foundation models 228, system 800 may in some embodiments include transformation and processing stage 216 and foundation models 228. In some embodiments, data sources 102 feeds into transformation and processing 216, which feeds into the foundation models 228, which then feeds into the output model 238. In some embodiments, however, input data 102 may be fed directly into output model 238. For example, in another embodiment, combined data set 218 may be part of the data sources 102 stage. As described elsewhere herein with respect to at least FIG. 2, each stage (e.g., data sources 102, transformation and processing 216, foundation models 228, output model 238) may include systems, methods, or devices (e.g., bank core system 204, net worth feature engineering 220, net worth model 228).

As described with at least respect to FIGS. 1 and 7, data sources 102 refers to any system, device, or application that produces or provides data. Non-limiting examples of data sources 102 include databases, data warehouses, sensors, web services, files, images, Application Programming Interfaces (APIs), or any other repository that produces or provides data. As shown, data sources 102 may include bank core system 204, CRM system 206, credit bureau system 208, demographic data system 210, county-level asset data system 212, federal reserve consumer survey 214, geographic wealth distribution system 702, or any other source of information. Data sources 102 may input data into the transformation and processing stage 216 or any other stage including output model 238. In some embodiments, data sources 102 feed directly into campaign execution model 812.

With respect to FIG. 8, data sources 102 in some embodiments include a customer list, a household list, product response 254, market response 722, bank core system 204, CRM system 206, credit bureau system 208, demographic data system 210, county-level asset data system 212, surveys 214, or geographic wealth distribution system 702. In some embodiments, the household list, product response 254, market response 722, bank core system 204, CRM system 206, credit bureau system 208, demographic data system 210, county-level asset data system 212, surveys 214, geographic wealth distribution system 702, or any other system may be input into campaign execution model 812. It is to be appreciated data sources 102 in system 800 may be input into campaign execution model 812 directly from systems 200 and 700. For example, data sources 102 included in system 700 (e.g., bank core system 204, county-level asset data system 212) may be included in system 800. In some embodiments, data sources 102 may be input into one or more transformation and processing stage 216, foundation model stage 228, or output model stage 238. Further, it is to be appreciated that in some embodiments customer list, household list, product response 254, market response 722, bank core system 204, CRM system 206, credit bureau system 208, demographic data system 210, county-level asset data system 212, surveys 214, or geographic wealth distribution system 702 are not part of data sources 102, but rather a different stage (e.g., transformation and processing 216, foundation models 228).

A campaign execution model 812 refers to systems, methods, or devices designed to develop optimized advertisements. For example, campaign execution model 812 may involve a series of activities, messages, and channels designed to achieve specific marketing goals. In some embodiments, campaign execution model 812 is a strategic system that involves developing optimized advertisements. In some embodiments, campaign execution model 812 is a machine learning algorithm used to send advertising instructions to marketing partners (e.g., third party providers). Campaign execution model 812 may include information related to specific marketing goals for a set period of time. In some embodiments, marketing campaign may be a strategic effort to promote products, services, or brands. Further, marketing campaigns may involve a combination of advertising, promotion, public relations, and other marketing tactics. In some embodiments, marketing campaign includes information related to objectives, target audience, messages, themes, channels, mediums, timing, duration, budget, or execution plans of advertisements.

In some embodiments, campaign execution model 812 inputs, receives, or extracts goal inputs 120. In some embodiments, goal inputs 120 may be stored in databases, data warehouses, web services, files, tables, images, or any other repository that stores data. By way of non-limiting example, goal inputs 120 involve bank product variants and parameters 240, bank products 242, bank regions 244, bank growth strategy 246, bank marketing budget 716, customer focus 718, or product response 254. In some embodiments, the bank product variants and parameters 240, bank products 242, bank regions 244, bank growth strategy 246, bank marketing budget 716, customer focus 718, and product response 254 may be inputted into the campaign execution model 812. It is to be appreciated that although the goal inputs 120 in the exemplary output model 238 refer to banks, goal inputs 120 may also be targeted to any other financial institution such as commercial banks, investment banks, credit unions, savings and loan associations (S&Ls), insurance companies, brokerage firms, pension funds, hedge funds, private equity firms, or central banks.

In some embodiments, the campaign execution model 812 is configured to input a request 724. In some embodiments, the request 724 is a system, method, or device related to a select subset of markets or regions. Request 724 may input information or data into campaign execution model 812. In some embodiments, the request 724 is run across a subset of markets or regions or across all available regions. Inputting subsets of markets or regions into the campaign execution model 812 allows for a more accurate campaign execution model 720 output, customized to a particular region.

Campaign duration 804 refers to a system, method, or device related to a period of time during which a specific advertising campaign is planned to run. In some embodiments, campaign duration 804 represents a timeline from the start of the advertising campaign to the end of the advertising campaign. Campaign duration 804 may be influenced by various factors such as marketing goals, budget constraints, product lifecycle, budget allocation, seasonal considerations, campaign objectives, competitive landscape, or product release schedules. Campaign duration 804 may be stored in databases, data warehouses, web services, files, tables, images, or any other repository that stores data.

Campaign budget 806 refers to a system, method, or device related to the allocated financial resources specifically designed for planning, executing, and managing a marketing campaign. In some embodiments, campaign budget 806 includes information related to the total amount of money allocated to cover various expenses associated with an advertising campaign. For example, campaign budget 806 may include information related to the total amount of money allocated to cover advertising, promotion, creative development, media buying, and other related costs. Non-limiting examples of factors involved in campaign budget 806 include allocating resources, budget planning and strategy, resource optimization, and return on investment. Campaign budget 806 may be stored in databases, data warehouses, web services, files, tables, images, or any other repository that stores data.

Available channels 810 refers to a system, method, or device related to communication and distribution channels through which a business or brand can reach and engage a target audience. In some embodiments, available channels 810 are mediums for delivering marketing messages which promote products or services. In further embodiments, available channels 810 interact are a means of interacting with customers. Available channels 810 may depend on goal inputs 120 or any other factor that impacts a business such as the nature of the business, target audience, marketing objectives, or industry trends. Non-limiting examples of available channels 810 include digital marketing channels (e.g., website, social media, email, search engine marketing), traditional marketing channels (e.g., television, radio, print media, mail), content marketing channels (e.g., blogs, podcasts, videos), retail channels (e.g., stores, e-commerce), event marketing channels (e.g., conferences, trade shows, sponsorships), public relations channels (e.g., press releases, media interviews), word-of-mouth channels (e.g., referral programs, customer reviews), affiliate marketing channels (e.g., affiliate programs), mobile marketing channels (e.g., mobile apps, SMS marketing), or emerging channels (e.g., augmented reality, visual reality, voice search). Available channels 810 may be stored in databases, data warehouses, web services, files, tables, images, or any other repository that stores data.

In some embodiments, campaign execution model 812 may output an advertisement response 814 based on the inputs of the campaign execution model 812. For example, the campaign execution model 812 may develop an advertisement response 814 including optimized advertisement instructions to be sent to marketing partners (e.g., third party providers) based on goal inputs 120 and request 724. It is to be appreciated advertisement response 814 may also be sent to other entities, models, or systems. Further, the campaign execution model 812 may output advertisement response 814 including an optimized list of advertising creatives, messages, audiences, and channels based on inputs to the campaign execution model 812. The campaign execution model 812 may further depend on product offering, product variants, and parameters based on request 724 and other goal inputs 120. In some embodiments, the advertisement response 814 includes a ranking and a likelihood scoring. The advertisement response 814, in some embodiments, is displayed on a user interface.

Advertisement response 814 refers to a system, method, or device related to optimized advertising creatives, messages, audiences, and channels. In some embodiments, advertisement response 814 is related to the target product output of FIG. 1, product response 254, or market response 722. Response, in some embodiments, are one or more product response 254, market response 722, or advertisement response 814 the financial institution offers based on the information provided to the system (e.g, system 200, system 700, system 800). Further, advertisement response 814, in some embodiments, is impacted by the way one or more feature engineering models, foundation models 228, and trained campaign execution model 812 are trained. Advertisement response 814 may be stored in databases, data warehouses, web services, files, tables, images, or any other repository that stores data.

In some embodiments, system 800 further comprises feedback loops. Feedback loops involve iterative updates and changes of data and systems. For example, feedback loops may allow processing device 122 to update input data 102, transformation and processing 216, foundation models 228, and output model 238. Further, feedback loops may feed an output of the system 800 (e.g., advertisement response 814) into the system 800 as an input, creating a cycle of self-regulation or adaption. For example, if new input data 102 becomes available or conditions of system 800 change, the processing device 122 may adjust accordingly. It is to be appreciated feedback loops may be implemented between any two variables, structures, components, devices, outputs, or other part of the system 800. Feedback loops maintain and enhance quality, functionality, and user experience over time. For example, in some embodiments, processing device 122 may update request 724 (e.g., market segment and regional segment) at predetermined times. In some embodiments, data sources 102 are updated daily, weekly, or monthly. Depending on client needs, models (e.g., foundation models 228, output model 238) may also be updated at regular intervals such as daily, weekly, or monthly. Processing device 122, in some embodiments, may provide updated request 724 (e.g., market segment and regional segment data) to the campaign execution model 812 in a fourth feedback loop. Further, the processing device 122 may train the trained campaign execution model 812 based upon information received from the fourth feedback loop to refine the trained campaign execution model 812. In some embodiments, feedback loops may fine-tune campaign execution model 812 at different levels (e.g., the household level). Feedback loops may allow administrator or processing device 122 to review mapping of the campaign execution model 812. Further, feedback loops may allow administrator or processing device 122 to include or exclude customers, regions, or products in the campaign execution model 812. Feedback loops, in some embodiments, allow administrator or processing device 122 to include or exclude existing or new customers in the campaign execution model 812. In some embodiments, feedback loops allow administrators or processing device 122 override request 724 or any information or configuration of the campaign execution model 720. In some embodiments, the system 800 may include one or more interconnected feedback loops. Further, feedback loops may be parallel feedback loops or nested feedback loops.

In some embodiments, the market response may suggest a market opportunity. This market opportunity may be correct (i.e., true positive prediction) or incorrect (i.e., false positive prediction). When the growth opportunity is executed upon (e.g., market strategy is deployed or executed), there may be a feedback loop. As the campaign is executed, labeled market data may be collected (indicating e.g., if the campaign is successful, if an entity should attribute new deposits, loans, client acquisition). Collected data may be fed back into one or more of the campaign execution model 812, growth opportunity model 720, and product mix model 248. As the campaign progresses, the underlying output models (e.g., campaign execution model 812, growth opportunity model 720, product mix model 248) may be refined or retrained based on market and client behavior.

In some embodiments, campaign execution model 812 inputs key performance indicator (KPI) feedback 816. KPI feedback 812 refers to systems, methods, or devices related to evaluating the success and performance of advertising campaigns. KPI feedback 812, in some embodiments, may measure aspects of an advertising campaign to assess effectiveness, identify areas of improvement, and make informed decisions. Non-limiting examples of KPI feedback 812 includes information related to click-through rate, conversion rate, cost per click, cost per conversion, number of times an ad is displayed to users, total number of unique users or households exposed to the ad, return on ad spend, view-through rate, likes, shares, or comments. In some embodiments, KPIs may depend on advertising campaign objectives. Further, third party providers may input KPI feedback 816 into system 800 or system 800 may automatically retrieve KPI feedback 816 from third party providers. KPI feedback 816 may be inputted into campaign execution model 812 in real-time or at predetermined times. In some embodiments, KPI feedback 816 is used to optimize response 814 including advertising creatives, messages, channels, and efficiency. KPI feedback 816 may be stored in databases, data warehouses, web services, files, tables, images, or any other repository that stores data.

Additional aspects of the present disclosure may be further described via the following clauses:

1. A system for artificial intelligence based product optimization of products and services for offer, comprising:
at least one non-transitory memory; and
at least one processing device, the memory containing software code configured to cause the processing device to:
   gather data from a plurality of data sources;
   extract, using a machine learning algorithm, at least one of a plurality of customer behavior features or a plurality of financial institution behavior features based on the gathered data;
   process the customer behavior features and financial institution behavior features using one or more trained foundation models, wherein the trained foundation models are selected based on a plurality of foundation model selection variables, and wherein the trained foundation models output one or more foundation model outputs;
   input the foundation model outputs and a plurality of goal inputs into a trained product model, wherein:
      the goal inputs comprise a plurality of financial institution products and one or more of a plurality of financial institution product variants, a plurality of financial institution parameters, a plurality of financial institution regions, or a plurality of financial institution growth strategies;
      the trained product model is trained based on the foundation model outputs and the goal inputs;
   output, from the trained product model, a natural-language product response, wherein the product response is based on the goal inputs.

2. The system of clause 1, wherein:
the data sources comprise one or more of banking core system, customer relationship management system, credit bureau system, country-level asset data system, survey, broker system, or external sources;
the gathered data comprises one or more of customer profile data, transaction history data, demographic information data, economic indicator data, household asset data, financial institution data, credit report data, or broker data;
the customer behavior features comprise one or more of customer lifetime value, spending patterns, or income levels; and
the financial institution behavior features comprise one or more of financial preferences or regional characteristics.

3. The system of clause 1, wherein:
the foundation model selection variables comprise one or more of the goal inputs; and
the processing device is further configured to:
   update the gathered data at predetermined times;
   provide the updated data to the machine learning algorithm through a first feedback loop; and
   modify the customer behavior features, financial institution features, and foundation model outputs based upon the updated data received from the first feedback loop to refine the machine learning algorithm.

4. The system of clause 1, wherein the trained product model comprises one or more of a logistic regression, a random forest, a gradient boosting, a clustering algorithm, or a deep learning model; and the processing device is further configured to:
update the goal inputs at predetermined times;
provide the updated goal input data to the trained product model in a second feedback loop; and
train the trained product model based upon the updated goal input data received from the second feedback loop to refine the trained product model.

5. The system of clause 1, wherein the processing device is further configured to:
receive customer feedback through one or more customer feedback channels, wherein the gathered data further comprises the customer feedback; and
adjust the goal inputs based on the customer feedback.

6. The system of clause 1, wherein the trained product model is further configured for one or more of collaborative filtering, content-based filtering, or hybrid recommendation filtering.

7. The system of clause 1, wherein the processing device is further configured to:
monitor the trained product model performance according to one or more trained product model metrics at predetermined times; and
refine the trained product model according to the trained product model performance.

8. The system of clause 1, wherein the target product output is based on a household segment or a client segment; and comprises a ranking and a likelihood scoring.

9. The system of clause 1, wherein the system further comprises a user interface configured to:
provide the user interface to a user device;
receive an input from the user device on one or more elements of the user interface; and
update the one or more of the data sources, the gathered data, the machine learning algorithm, the customer behavior features, the financial institution behavior features, the trained models, the foundation model selection variables, the goal inputs, or the trained product model in response to the input; and
display an updated product response based on the input.

10. The system of clause 1, wherein the gathered data comprises customer data and financial institution data.

11. A method for artificial-intelligence based product optimization of products and services for offer comprising:
gathering data from a plurality of data sources;
extracting, using a machine learning algorithm, a plurality of customer behavior features and a plurality of financial institution behavior features based on the gathered data;
processing the customer behavior features and financial institution behavior features using one or more trained foundation models, wherein the trained foundation models are selected based on a plurality of foundation model selection variables, and wherein the foundation models output one or more foundation model outputs;
inputting the foundation model outputs and a plurality of goal inputs into a trained product model, wherein:
   the goal inputs comprise a plurality of financial institution products and one or more of a plurality of financial institution product variants, a plurality of financial institution parameters, a plurality of financial institution regions, or a plurality of financial institution growth strategies;
   the trained product model is trained based on the foundation model outputs and the goal inputs;
outputting, from the trained product model, a natural-language target product output, wherein the target product output is based on the goal inputs.

12. The method of clause 11, wherein:
the data sources comprise one or more of banking core system, customer relationship management system, credit bureau system, country-level asset data system, survey, or external sources;
the gathered data comprises one or more of customer profile data, transaction history data, demographic information data, economic indicator data, household asset data, financial institution data, credit report data, or broker data;
the customer behavior features comprise one or more of customer lifetime value, spending patterns, or income levels; and
the financial institution behavior features comprise one or more of financial preferences or regional characteristics.

13. The method of clause 11, wherein:
the foundation model selection variables comprise one or more of the goal inputs; and
the method further comprises:
   updating the gathered data at predetermined times;
   providing the updated data to the machine learning algorithm through a first feedback loop; and
   modifying the customer behavior features and foundation model outputs based upon the updated data received from the first feedback loop to refine the machine learning algorithm.

14. The method of clause 11, wherein the trained product model comprises one or more of a logistic regression, a random forest, a gradient boosting, a clustering algorithm, or a deep learning model; and the method further comprises:
updating the goal inputs at predetermined times;
providing the updated goal input data to the trained product model in a second feedback loop; and
training the trained product model based upon information received from the second feedback loop to refine the trained product model.

15. The method of clause 11, further comprising:
receiving customer feedback through one or more customer feedback channels, wherein the gathered data further comprises the customer feedback; and
adjusting the goal inputs based on the customer feedback.

16. The method of clause 11, wherein the trained model is further configured for collaborative filtering, content-based filtering, and hybrid recommendation filtering.

17. The method of clause 11, further comprising:
monitoring the trained product model performance according to one or more trained product model metrics at predetermined times; and
refining the trained product model according to the trained product model performance.

18. The method of clause 11, wherein the target product output is based on a household segment or a client segment; and comprises a ranking and a likelihood scoring.

19. The method of clause 11, wherein the method system further comprises: providing a user interface to a user device;
receiving an input from the user device on one or more elements of the user interface; and
updating the one or more of the data sources, the gathered data, the machine learning algorithm, the customer behavior features, the financial institution behavior features, the trained models, the foundation model selection variables, the goal inputs, or the trained product model in response to the input; and
displaying an updated product response based on the input.

20. The method of clause 11, wherein the gathered data comprises customer data and financial institution data.

21. A system for identifying, using artificial intelligence, a combination of geographic areas for growth comprising:
at least one non-transitory memory; and
at least one processing device, the memory containing software code configured to cause the processing device to:
   gather data from a plurality of data sources;
   extract, using a machine learning algorithm, at least one of a plurality of customer behavior features or a plurality of financial institution behavior features based on the gathered data;
   process the customer behavior features and financial institution behavior features using one or more trained foundation models, wherein the trained foundation models are selected based on a plurality of foundation model selection variables, and wherein the trained foundation models output one or more foundation model outputs related to one or more of a competitiveness of a market or a future outlook of a region for a product;
   input the foundation model outputs and a plurality of goal inputs into a trained growth opportunity model, wherein:
      the goal inputs comprise a plurality of financial institution products and one or more of a plurality of financial institution product variants, a plurality of financial institution parameters, a plurality of financial institution regions, a plurality of financial institution growth strategies, a request, a financial institution marketing budget, or a customer focus;
      the trained growth opportunity model is trained based on the foundation model outputs and the goal inputs;
   output, from the trained growth opportunity model, a natural-language market response, wherein the market response is based on the goal inputs.

22. The system of clause 21, wherein:
the foundation model selection variables comprise one or more of the goal inputs; and
the processing device is further configured to:
   update the gathered data at predetermined times;
   provide the updated data to the machine learning algorithm through a first feedback loop; and
   modify the customer behavior features, the financial institution financial features, foundation model outputs based upon the updated data received from the first feedback loop to refine the machine learning algorithm.

23. The system of clause 21, wherein the trained growth opportunity model comprises one or more of a logistic regression, a random forest, a gradient boosting, a clustering algorithm, or a deep learning model; and the processing device is further configured to:
update the goal inputs at predetermined times;
provide the updated goal input data to the trained growth opportunity model in a second feedback loop; and
train the trained growth opportunity model based upon the updated goal input data received from the second feedback loop to refine the trained growth opportunity model.

24. The system of clause 21, wherein the processing device is further configured to:
receive customer feedback through one or more customer feedback channels, wherein the gathered data further comprises the customer feedback; and
adjust the goal inputs based on the customer feedback.

25. The system of clause 21, wherein the trained growth opportunity model is
further configured for one or more collaborative filtering, content-based filtering, or hybrid recommendation filtering.

26. The system of clause 21, wherein the processing device is further configured to:
monitor the trained growth opportunity model performance according to one or more trained growth opportunity model metrics at predetermined times; and
refine the trained growth opportunity model according to the trained growth opportunity model performance.

27. The system of clause 21, wherein the market response is based on a market segment including one or more of a demographic segment, a geographic segment, a psychographic segment, a behavioral segment or a regional segment including one or more of a geographic scope, state, province, district, or parish; and
comprises a ranking and a likelihood scoring.

28. The system of clause 21, wherein the market response comprises a top market; and
the processing device is further configured to:
   update the market segment and the regional segment at predetermined times;
   provide the updated market segment and regional segment data to the trained growth opportunity model in a third feedback loop; and
   train the trained growth opportunity model based upon updated market segment data and updated regional segment data received from the third feedback loop to refine the trained growth opportunity model.

29. The system of clause 21, wherein the system further comprises a user interface configured to:
provide the user interface to a user device;
receive an input from the user device on one or more elements of the user interface; and
update the one or more of the data sources, the gathered data, the machine learning algorithm, the customer behavior features, the financial institution behavior features, the trained models, the foundation model selection variables, the goal inputs, or the growth opportunity model in response to the input; and
display an updated market response based on the input.

30. The system of clause 21, wherein the gathered data comprises customer data and financial institution data.

31. A method for identifying, using artificial intelligence, a combination of geographic areas for growth comprising:
gathering data from a plurality of data sources;
extracting, using a machine learning algorithm, at least one of a plurality of customer behavior features or a plurality of financial institution behavior features based on the gathered data;
processing the customer behavior features and financial institution behavior features using one or more trained foundation models, wherein the trained foundation models are selected based on a plurality of foundation model selection variables, and wherein the foundation models output one or more foundation model outputs related to one or more of a competitiveness of a market or a future outlook of a region for a product;
inputting the foundation model outputs and a plurality of goal inputs into a trained growth opportunity model, wherein:
   the goal inputs comprise a plurality of financial institution products and one or more of a plurality of financial institution product variants, a plurality of financial institution parameters, a plurality of financial institution regions, a plurality of financial institution growth strategies, a product response, a financial institution marketing budget, or a customer focus;
   the trained growth opportunity model is trained based on the foundation model outputs and the goal inputs;
outputting, from the trained growth opportunity model, a natural-language market response, wherein the market response is based on the goal inputs.

32. The method of clause 31, wherein:
the foundation model selection variables comprise one or more of the goal inputs; and
the method further comprises:
   updating the gathered data at predetermined times;
   providing the updated data to the machine learning algorithm through a first feedback loop; and
   modifying the customer behavior features, financial institution features, and foundation model outputs based upon the updated data received from the first feedback loop to refine the machine learning algorithm.

33. The method of clause 31, wherein the trained growth opportunity model comprises one or more of a logistic regression, a random forest, a gradient boosting, a clustering algorithm, or a deep learning model; and the method further comprises:
updating the goal inputs at predetermined times;
providing the updated goal input data to the trained growth opportunity model in a second feedback loop; and
training the trained growth opportunity model based upon the updated goal input data received from the second feedback loop to refine the trained growth opportunity model.

34. The method of clause 31, further comprising:
receiving customer feedback through one or more customer feedback channels, wherein the gathered data further comprises the customer feedback; and
adjusting the goal inputs based on the customer feedback.

35. The method of clause 31, wherein the trained model is further configured for collaborative filtering, content-based filtering, and hybrid recommendation filtering.

36. The method of clause 31, further comprising:
monitoring the trained growth opportunity model performance according to one or more trained growth opportunity model metrics at predetermined times; and
refining the trained growth opportunity model according to the trained growth opportunity model performance.

37. The method of clause 31, wherein the market response is based on a market segment including one or more of a demographic segment, a geographic segment, a psychographic segment, a behavioral segment or a regional segment including one or more of a geographic scope, state, province, district, or parish; and comprises a ranking and a likelihood scoring.

38. The method of clause 31, wherein the market response comprises a top market; and further comprising:
updating the market segment and regional segment at predetermined times;
providing the updated market segment and the updated regional segment data to the trained growth opportunity model in a third feedback loop; and
training the trained growth opportunity model based upon information received from the third feedback loop to refine the trained growth opportunity model.

39. The method of clause 31, further comprising:
configuring a user interface to:
   provide the user interface to a user device;
   receive an input from the user device on one or more elements of the user interface; and
   update the one or more of the data sources, the gathered data, the machine learning algorithm, the customer behavior features, the financial institution behavior features, the trained models, the foundation model selection variables, the goal inputs, or the trained growth opportunity model in response to the input; and
   display an updated market response based on the input.

40. The method of clause 31, wherein the gathered data comprises customer data and financial institution data.

41. A system for developing, using artificial intelligence, optimized advertisements comprising:
at least one non-transitory memory; and
   at least one processing device, the memory containing software code configured to cause the processing device to:
      gather data from a plurality of data sources;
      extract, using a machine learning algorithm, at least one of a plurality of customer behavior features or a plurality of financial institution behavior features based on the gathered data;
      process the customer behavior features and financial institution behavior features using one or more trained foundation models, wherein the trained foundation models are selected based on a plurality of foundation model selection variables, and wherein the trained foundation models output one or more foundation model outputs related to an advertisement instruction;
      input the foundation model outputs and a plurality of goal inputs into a trained campaign execution model, wherein:
         the goal inputs comprise one or more of a plurality of financial institution products, a plurality of financial institution product variants, a plurality of financial institution parameters, a plurality of financial institution regions, a plurality of financial institution growth strategies, a product response, a market response, a plurality of a campaign duration, a campaign budget, or an available campaign channel;
         the trained campaign execution model is trained based on the foundation model outputs and the goal inputs;
      output, from the trained campaign execution model, a natural-language advertisement response, wherein the advertisement response is based on the goal inputs.

42. The system of clause 41, wherein
the foundation model selection variables comprise one or more of the goal inputs; and
the processing device is further configured to:
   update the gathered data at predetermined times;
   provide the updated data to the machine learning algorithm through a first feedback loop; and
   modify the customer behavior features, financial institution features, and foundation model outputs based upon information received from the first feedback loop to refine the machine learning algorithm.

43. The system of clause 41, wherein the trained campaign execution model comprises one or more of a logistic regression, a random forest, a gradient boosting, a clustering algorithm, or a deep learning model; and the processing device is further configured to:
update the goal inputs at predetermined times;
provide the updated goal input data to the trained campaign execution model in a second feedback loop; and
train the trained campaign execution model based upon information received from the second feedback loop to refine the trained campaign execution model.

44. The system of clause 41, wherein the processing device is further configured to:
receive customer feedback through one or more customer feedback channels, wherein the gathered data further comprises the customer feedback; and
adjust the goal inputs based on the customer feedback.

45. The system of clause 41, wherein the trained campaign execution model is further configured for one or more collaborative filtering, content-based filtering, or hybrid recommendation filtering.

46. The system of clause 41, wherein the processing device is further configured to:
monitor the trained campaign execution model performance according to one or more trained campaign execution model metrics at predetermined times; and
refine the trained campaign execution model according to the trained campaign execution model performance.

47. The system of clause 41, wherein the advertisement response comprises an ad instruction; and
the processing device is further configured to:
   monitor a plurality of key performance indicators;
   update the trained campaign execution model based on the key performance indicators in a third feedback loop; and
   train the trained campaign execution model based upon information received from the third feedback loop to refine the trained campaign execution model.

48. The system of clause 41, wherein the system further comprises a user interface configured to:
provide the user interface to a user device;
receive an input from the user device on one or more elements of the user interface; and
update the one or more of the data sources, the gathered data, the machine learning algorithm, the customer behavior features, the financial institution behavior features, the trained models, the foundation model selection variables, the goal inputs, or the trained product model in response to the input; and
display an updated advertisement response based on the input.

49. The system of clause 41, wherein the gathered data comprises customer data and financial institution data.

50. A method for developing, using artificial intelligence, optimized advertisements comprising:
gathering data from a plurality of data sources;
extracting, using a machine learning algorithm, at least one of a plurality of customer behavior features or a plurality of financial institution behavior features based on the gathered data;
processing the customer behavior features and financial institution behavior features using one or more trained foundation models, wherein the trained foundation models are selected based on a plurality of foundation model selection variables, and wherein the foundation models output one or more foundation model outputs related to an advertisement instruction;
inputting the foundation model outputs and a plurality of goal inputs into a trained campaign execution model, wherein:
   the goal inputs comprise one or more of a plurality of financial institution products, a plurality of financial institution product variants, a plurality of financial institution parameters, a plurality of financial institution regions, a plurality of financial institution growth strategies, a response, a plurality of a campaign duration, a campaign budget, or an available campaign channel;
   the trained campaign execution model is trained based on the foundation model outputs and the goal inputs;
outputting, from the trained campaign execution model, a natural-language advertisement response, wherein the advertisement response is based on the goal inputs.

51. The method of clause 50, wherein
the foundation model selection variables comprise one or more of the goal inputs; and
the method further comprises:
   updating the gathered data at predetermined times;
   providing the updated data to the machine learning algorithm through a first feedback loop; and
   modifying the customer behavior features, the financial institution features, and foundation model outputs based upon information received from the first feedback loop to refine the machine learning algorithm.

52. The method of clause 50, wherein the trained campaign execution model comprises one or more of a logistic regression, a random forest, a gradient boosting, a clustering algorithm, or a deep learning model; and the method further comprises:
updating the goal inputs at predetermined times;
providing the updated goal input data to the trained campaign execution model in a second feedback loop; and
training the trained campaign execution model based upon information received from the second feedback loop to refine the trained campaign execution model.

53. The method of clause 50, further comprising:
receiving customer feedback through one or more customer feedback channels, wherein the gathered data further comprises the customer feedback; and
adjusting the goal inputs based on the customer feedback.

54. The method of clause 50, wherein the trained model is further configured
for collaborative filtering, content-based filtering, and hybrid recommendation filtering.

55. The method of clause 50, further comprising:
monitoring the trained campaign execution model performance according to one or more trained campaign execution model metrics at predetermined times; and
refining the trained campaign execution model according to the trained campaign execution model performance.

56. The method of clause 50, wherein the advertisement response comprises an ad instruction; and the method further comprising:
monitoring a plurality of key performance indicators;
updating the trained campaign execution model based on the key performance indicators in a third feedback loop; and
training the trained campaign execution model based upon information received from the third feedback loop to refine the trained campaign execution model.

57. The method of clause 50, further comprising:
providing a user interface to a user device;
receiving an input from the user device on one or more elements of the user interface; and
updating the one or more of the data sources, the gathered data, the machine learning algorithm, the customer behavior features, the financial institution behavior features, the trained models, the foundation model selection variables, the goal inputs, or the trained campaign execution model in response to the input; and
display an updated advertisement response based on the input.

58. The method of clause 50, wherein the gathered data comprises customer data and financial institution data.

The foregoing description has been presented for purposes of illustration. It is not exhaustive and is not limited to precise forms or embodiments disclosed. Modifications and adaptations of the embodiments will be apparent from consideration of the specification and practice of the disclosed embodiments. For example, the described implementations include hardware, but systems and methods consistent with the present disclosure can be implemented with hardware and software. Furthermore, non-transitory computer-readable media can contain instructions, that when executed by one or more processor or processing device, cause a computing system (e.g., a cloud computing platform, computing cluster, or the like) to implement the disclosed systems and methods. In addition, while certain components have been described as being coupled to one another, such components may be integrated with one another or distributed in any suitable fashion.

While illustrative embodiments have been described herein, the scope includes any and all embodiments having equivalent elements, modifications, omissions, combinations (e.g., of aspects across various embodiments), adaptations or alterations based on the present disclosure. The elements in the claims are to be interpreted broadly based on the language employed in the claims and not limited to examples described in the present specification or during the prosecution of the application, which examples are to be construed as nonexclusive. Further, the steps of the disclosed methods can be modified in any manner, including reordering steps or inserting or deleting steps.

The features and advantages of the disclosure are apparent from the detailed specification, and thus, it is intended that the appended claims cover all systems and methods falling within the true spirit and scope of the disclosure. As used herein, the indefinite articles “a” and “an” mean “one or more.” Similarly, the use of a plural term does not necessarily denote a plurality unless it is unambiguous in the given context. Further, since numerous modifications and variations will readily occur from studying the present disclosure, it is not desired to limit the disclosure to the exact construction and operation illustrated and described, and accordingly, all suitable modifications and equivalents may be resorted to, falling within the scope of the disclosure.

As used herein, unless specifically stated otherwise, the term “or” encompasses all possible combinations, except where infeasible. For example, if it is stated that a component may include A or B, then, unless specifically stated otherwise or infeasible, the component may include A, or B, or A and B. As a second example, if it is stated that a component may include A, B, or C, then, unless specifically stated otherwise or infeasible, the component may include A, or B, or C, or A and B, or A and C, or B and C, or A and B and C.

Other embodiments will be apparent from consideration of the specification and practice of the embodiments disclosed herein. It is intended that the specification and examples be considered as example only, with a true scope and spirit of the disclosed embodiments being indicated by the following claims.

What is claimed is:

1. A system for artificial intelligence based product optimization of products and services for offer, comprising:
at least one non-transitory memory; and
at least one processing device, the memory containing software code configured to cause the processing device to:
gather data from a plurality of data sources;
extract, using a machine learning algorithm, at least one of a plurality of customer behavior features or a plurality of financial institution behavior features based on the gathered data;
process the customer behavior features and financial institution behavior features using one or more trained foundation models, wherein the trained foundation models are selected based on a plurality of foundation model selection variables, and wherein the trained foundation models output one or more foundation model outputs;
input the foundation model outputs and a plurality of goal inputs into a trained product model, wherein:
the goal inputs comprise a plurality of financial institution products and one or more of a plurality of financial institution product variants, a plurality of financial institution parameters, a plurality of financial institution regions, or a plurality of financial institution growth strategies;
the trained product model is trained based on the foundation model outputs and the goal inputs;
output, from the trained product model, a natural-language product response, wherein the product response is based on the goal inputs.

2. The system of claim 1, wherein:
the data sources comprise one or more of banking core system, customer relationship management system, credit bureau system, country-level asset data system, survey, broker system, or external sources;
the gathered data comprises one or more of customer profile data, transaction history data, demographic information data, economic indicator data, household asset data, financial institution data, credit report data, or broker data;
the customer behavior features comprise one or more of customer lifetime value, spending patterns, or income levels; and
the financial institution behavior features comprise one or more of financial preferences or regional characteristics.

3. The system of claim 1, wherein:
the foundation model selection variables comprise one or more of the goal inputs; and
the processing device is further configured to:
update the gathered data at predetermined times;
provide the updated data to the machine learning algorithm through a first feedback loop; and
modify the customer behavior features, financial institution features, and foundation model outputs based upon the updated data received from the first feedback loop to refine the machine learning algorithm.

4. The system of claim 1, wherein the trained product model comprises one or more of a logistic regression, a random forest, a gradient boosting, a clustering algorithm, or a deep learning model; and
the processing device is further configured to:
update the goal inputs at predetermined times;
provide the updated goal input data to the trained product model in a second feedback loop; and
train the trained product model based upon the updated goal input data received from the second feedback loop to refine the trained product model.

5. The system of claim 1, wherein the processing device is further configured to:
receive customer feedback through one or more customer feedback channels,
wherein the gathered data further comprises the customer feedback; and
adjust the goal inputs based on the customer feedback.

6. The system of claim 1, wherein the trained product model is further configured for one or more of collaborative filtering, content-based filtering, or hybrid recommendation filtering.

7. The system of claim 1, wherein the processing device is further configured to:
monitor the trained product model performance according to one or more trained product model metrics at predetermined times; and
refine the trained product model according to the trained product model performance.

8. The system of claim 1, wherein the target product output is based on a household segment or a client segment; and comprises a ranking and a likelihood scoring.

9. The system of claim 1, wherein the system further comprises a user interface configured to:
provide the user interface to a user device;
receive an input from the user device on one or more elements of the user interface; and
update the one or more of the data sources, the gathered data, the machine learning algorithm, the customer behavior features, the financial institution behavior features, the trained models, the foundation model selection variables, the goal inputs, or the trained product model in response to the input; and
display an updated product response based on the input.

10. The system of claim 1, wherein the gathered data comprises customer data and financial institution data.

11. A method for artificial-intelligence based product optimization of products and services for offer comprising:
gathering data from a plurality of data sources;
extracting, using a machine learning algorithm, a plurality of customer behavior features and a plurality of financial institution behavior features based on the gathered data;
processing the customer behavior features and financial institution behavior features using one or more trained foundation models, wherein the trained foundation models are selected based on a plurality of foundation model selection variables, and wherein the foundation models output one or more foundation model outputs;
inputting the foundation model outputs and a plurality of goal inputs into a trained product model, wherein:
the goal inputs comprise a plurality of financial institution products and one or more of a plurality of financial institution product variants, a plurality of financial institution parameters, a plurality of financial institution regions, or a plurality of financial institution growth strategies;
the trained product model is trained based on the foundation model outputs and the goal inputs;
outputting, from the trained product model, a natural-language target product output, wherein the target product output is based on the goal inputs.

12. The method of claim 11, wherein:
the data sources comprise one or more of banking core system, customer relationship management system, credit bureau system, country-level asset data system, survey, or external sources;
the gathered data comprises one or more of customer profile data, transaction history data, demographic information data, economic indicator data, household asset data, financial institution data, credit report data, or broker data;
the customer behavior features comprise one or more of customer lifetime value, spending patterns, or income levels; and
the financial institution behavior features comprise one or more of financial preferences or regional characteristics.

13. The method of claim 11, wherein:
the foundation model selection variables comprise one or more of the goal inputs; and
the method further comprises:
updating the gathered data at predetermined times;
providing the updated data to the machine learning algorithm through a first feedback loop; and
modifying the customer behavior features and foundation model outputs based upon the updated data received from the first feedback loop to refine the machine learning algorithm.

14. The method of claim 11, wherein the trained product model comprises one or more of a logistic regression, a random forest, a gradient boosting, a clustering algorithm, or a deep learning model; and
the method further comprises:
updating the goal inputs at predetermined times;
providing the updated goal input data to the trained product model in a second feedback loop; and
training the trained product model based upon information received from the second feedback loop to refine the trained product model.

15. The method of claim 11, further comprising:
receiving customer feedback through one or more customer feedback channels,
wherein the gathered data further comprises the customer feedback; and
adjusting the goal inputs based on the customer feedback.

16. The method of claim 11, wherein the trained model is further configured for collaborative filtering, content-based filtering, and hybrid recommendation filtering.

17. The method of claim 11, further comprising:
monitoring the trained product model performance according to one or more trained product model metrics at predetermined times; and
refining the trained product model according to the trained product model performance.

18. The method of claim 11, wherein the target product output is based on a household segment or a client segment; and comprises a ranking and a likelihood scoring.

19. The method of claim 11, wherein the method system further comprises:
providing a user interface to a user device;
receiving an input from the user device on one or more elements of the user interface; and
updating the one or more of the data sources, the gathered data, the machine learning algorithm, the customer behavior features, the financial institution behavior features, the trained models, the foundation model selection variables, the goal inputs, or the trained product model in response to the input; and
displaying an updated product response based on the input.

20. The method of claim 11, wherein the gathered data comprises customer data and financial institution data.
